(19) United States
(12) Patent Application Publication
(10) Pub. No.: US 2026/0093980 A1
(43) Pub. Date: Apr. 2, 2026

(54) Method and Apparatus for Determining the Physical State of an Object

(71) Applicant: Robert Bosch GmbH, Stuttgart (DE)

(72) Inventors: Kaixuan Zhang, Shanghai (CN); Jianing Huang, Shanghai (CN); Youjia Wu, Shanghai (CN); Ze Cheng, Shanghai (CN)

(21) Appl. No.: 19/342,597

(22) Filed: Sep. 28, 2025

(30) Foreign Application Priority Data
Sep. 30, 2024 (CN) 2024 1138 1861.9

(51) Int. Cl. G06N 3/08

(52) U.S. Cl. CPC G06N 3/08

(57) ABSTRACT

A computer-implemented method for generating training data includes (i) generating a basic shape, (ii) configuring the boundary conditions associated with a first partial differential equation (PDE) for the boundary of the basic shape, and (iii) determining a solution of the first PDE for the basic shape based on the basic shape and the boundary conditions, wherein the solution represents the physical state of an object having the basic shape. The training data is obtained based on the basic shape, the boundary conditions, and the solution.

This application claims priority under 35 U.S.C. § 119 to application no. CN 2024 1138 1861.9, filed on Sep. 30, 2024 in China, the disclosure of which is incorporated herein by reference in its entirety.

The present application relates to artificial intelligence technology, and more particularly, to s method and apparatus for determining the physical state of an object.

### BACKGROUND

Neural network (NN) models (e.g., NN operators) are becoming increasingly popular in solving partial differential equations (PDEs) because they have an exceptional ability to capture complex mappings between function spaces over complex domains. However, existing frameworks based on shape-specific NN models create bottlenecks for the widespread application of the NN models. On the one hand, the training of NN models requires large amounts of training data. For example, in structural engineering, a product may have a specific shape and may therefore require the use of a NN model for that specific shape to calculate the physical state (e.g., speed, pressure, temperature, electric field, magnetic field, etc.) of the product having that shape, and accordingly, it may be necessary to use training data for this specific shape may to train the NN model. However, the amount of data for the training data for the specific shape may sometimes be insufficient, resulting in poor performance of the NN model for the specific shape trained with that training data.

On the other hand, it is difficult for the NN models in the existing frameworks described above to generalize from the shapes used in the training data to completely different (e.g., not included in the training data) new shapes. For example, a first NN model may be trained for a first shape (e.g., a first product). For a second product having a second shape, the first NN model may produce undesirable results when predicting the physical state for the second product, since the second shape is completely different from the first shape. In this case, the second NN model must be retrained for the second shape. This leads to lower efficiency and hinders the application of NN models to real-world issues in the industry.

Therefore, an improved system for determining the physical state of an object is desired, wherein the NN model is not limited to the shape of a specific product and sufficient training data can be generated for the NN model; such an improved system can utilize the NN model to better generalize to any shape, thereby determining the physical state of various objects with different shapes and improving the efficiency of the use of the NN model in practical industrial applications.

### SUMMARY

The following introduction is provided in order to introduce some selected concepts in a simple manner, and these concepts will be further described in the detailed description below. The introduction is not intended to highlight the key or necessary features of the claimed subject matter, nor is it intended to limit the scope of the claimed subject matter.

In response to the above problems, the present application provides a novel computer-implemented method for generating training data and, accordingly, a novel framework for determining the physical state of an object having a shape using an NN model. By employing the methods of the various examples of the present application, it is possible to generate sufficient training data for the NN model so that the NN model provides ideal performance, and the physical state of objects of any shape can be determined based on this trained NN model, thereby improving the training and usage efficiency of the NN model.

According to one aspect of the present application, a computer-implemented method for generating training data is provided, comprising: generating a basic shape; configuring the boundary conditions associated with a first partial differential equation (PDE) for the boundary of the basic shape; determining a solution of the first PDE for the basic shape based on the basic shape and the boundary conditions, wherein the solution represents the physical state of an object having the basic shape; and wherein the training data is obtained based on the basic shape, the boundary conditions, and the solution.

According to one aspect of the present application, a computer-implemented method for training a neural network (NN) model for determining the physical state of an object having a shape is provided, comprising: predicting, by the NN model, a solution for a basic shape in the training data based on the training data generated by the method according to examples of the present disclosure, wherein the solution represents the physical state of an object having the basic shape; determining a loss based on a solution predicted by the NN model and a solution in the training data; and updating a learnable parameter of the NN model based on the loss.

According to one aspect of the present application, a computer-implemented method for determining the physical state of an object having a shape is provided, comprising: partitioning the shape of the object into a plurality of sub-shapes, wherein a full set of a plurality of sub-regions corresponding to the plurality of sub-shapes covers the complete area of the shape; based on the global boundary conditions of the shape and the plurality of sub-shapes, obtaining a local solution for each of the plurality of sub-shapes through a neural network (NN) model, the local solution for each sub-shape representing the local physical state of the object having the sub-shape; and obtaining a global solution for the shape based on the local solution for each of the plurality of sub-shapes, the global solution for the shape representing the physical state of the object.

According to one aspect of the present application, a computer-implemented method for performing structural optimization on an object is provided, comprising: predicting the physical state of an object using the method according to the present application; and updating the structural features of the object based on the predicted physical state of the object.

According to one aspect of the present application, an apparatus for generating training data is provided, comprising: a shape generation module that generates a basic shape; a boundary condition module that configures the boundary conditions associated with a first partial differential equation (PDE) for the boundary of the basic shape; a solution module that determines a solution of the first PDE for the basic shape based on the basic shape and the boundary conditions, wherein the solution represents the physical state of an object having the basic shape; and wherein the training data is obtained based on the basic shape, the boundary conditions, and the solution. According to one aspect of the present application, an apparatus for training a neural network (NN) model for determining the physical state of an object having a shape is provided, comprising: an NN model that predicts a solution for a basic shape based on basic shapes and boundary conditions in training data generated by the method according to examples of the present disclosure, wherein the solution represents the physical state of an object having the basic shape; a loss module that determines a loss based on a solution predicted by the NN model and a solution in the training data; and an update module that updates a learnable parameter of the NN model based on the loss.

According to one aspect of the present application, an apparatus determining the physical state of an object having a shape is provided, comprising: a partitioning module that partitions the shape of the object into a plurality of sub-shapes, wherein a full set of a plurality of sub-regions corresponding to the plurality of sub-shapes covers the complete area of the shape; a local solution module that obtains a local solution for each of the plurality of sub-shapes based on the global boundary conditions of the shape and the plurality of sub-shapes through a neural network (NN) model, the local solution for each sub-shape representing the local physical state of the object having the sub-shape; obtaining a global solution for the shape based on the local solution for each of the plurality of sub-shapes, the global solution for the shape representing the physical state of the object.

According to one aspect of this application, an apparatus for performing structural optimization on an object is provided, comprising: a prediction module that predicts the physical state of an object using the method according to examples of the present disclosure; and an update module that updates the structural features of the object based on the predicted physical state of the object.

According to one aspect of the present application, a processing apparatus is provided, comprising: one or more processors; and one or more memories storing computer-executable instructions that, when executed by the one or more processors, perform at least one of the operations of generating training data, training a NN model for determining the physical state of an object having a shape, determining the physical state of an object having a shape, and performing structural optimization on an object according to examples of the present disclosure.

According to one aspect of the present application, a machine-readable storage medium is provided, which stores executable instructions that, when executed, cause one or more processors to perform at least one of the operations of generating training data, training an NN model for determining the physical state of an object having a shape, determining the physical state of an object having a shape, and performing structural optimization on an object according to examples of the present disclosure.

According to one aspect of the present application, a computer program product is provided, which comprises executable instructions that, when executed, cause one or more processors to perform at least one of the operations of generating training data, training an NN model for determining the physical state of an object having a shape, determining the physical state of an object having a shape, and performing structural optimization on an object according to examples of the present disclosure.

### BRIEF DESCRIPTION OF THE DRAWINGS

The nature and advantages of the content of the present application may be further implemented by referring to the following accompanying drawings.

In the drawings, similar components or features may have the same reference signs.

FIG. 1 shows a block diagram of an apparatus for generating training data and training an NN model according to one example.

FIG. 2A shows a schematic diagram of a basic shape generated according to one example.

FIG. 2B shows a schematic diagram of a discretized basic shape generated according to one example.

FIG. 2C shows a schematic diagram of a shape generation module according to one example.

FIG. 3A shows a schematic diagram of a basic shape configured with a single boundary condition according to one example.

FIG. 3B shows a schematic diagram of a basic shape configured with mixed boundary conditions according to one example.

FIG. 3C shows a schematic diagram of a boundary condition module according to one example.

FIG. 4A shows a schematic diagram of a solution for a basic shape determined according to one example.

FIG. 4B shows a schematic diagram of a data-augmented basic shape and solution according to one example.

FIG. 5 shows a schematic diagram for training an NN model according to one example.

FIG. 6A shows a block diagram of an apparatus for determining the physical state of an object having a shape according to one example.

FIG. 6B shows a schematic diagram for determining the physical state of an object having a shape according to one example.

FIG. 7A shows a schematic diagram of partitioning a shape into a plurality of non-overlapping sub-shapes according to one example.

FIG. 7B shows a schematic diagram of partitioning a shape into a plurality of overlapping sub-shapes according to one example.

FIG. 7C shows a schematic diagram of an overlapping partitioning module according to one example.

FIG. 8 shows a schematic diagram of a local solution module according to one example.

FIG. 9 shows a schematic diagram of a global solution module according to one example.

FIG. 10 shows a schematic diagram of shapes and the data efficiency of applying SNI to each shape according to one example of the present disclosure.

FIG. 11 shows a schematic diagram of an object having a shape according to one example.

FIG. 12 shows a flow chart of a method for performing structural optimization on an object according to one example.

FIG. 13 shows a flow chart of a computer-implemented method for generating training data according to one example.

FIG. 14 shows a flow chart of a computer-implemented method for training an NN model for determining the physical state of an object having a shape according to one example.

FIG. 15 shows a flow chart of a computer-implemented method for determining the physical state of an object having a shape according to one example.

FIG. 16 shows a flow chart of a computer-implemented method for performing structural optimization on an object according to one example.

FIG. 17 shows a block diagram of an apparatus for generating training data according to one example.

FIG. 18 shows a block diagram of an apparatus for training an NN model for determining the physical state of an object having a shape according to one example.

FIG. 19 shows a block diagram of an apparatus for determining the physical state of an object having a shape according to one example.

FIG. 20 shows a block diagram of an apparatus for performing structural optimization on an object according to one example.

FIG. 21 shows a block diagram of a processing apparatus according to one example.

### DETAILED DESCRIPTION

The subject matter described herein will now be discussed with reference to exemplary implementations. It should be understood that discussions about these embodiments are provided to aid those skilled in the art in better understanding and thereby implementing the subject matter described herein rather than limiting the scope of protection, applicability, or examples described in the patent claims. Changes may be made to the functions and arrangements of the elements discussed without departing from the scope of protection of the content of the present application. Various processes or components may be omitted, substituted, or added in the various examples as needed. For example, the described method may be performed in a different order than that described, and various steps may be added, omitted, or combined. In addition, features described in relation to some examples may also be combined in other examples.

As used herein, the term “comprising” and its variations are open terms, which mean “including but not limited to.” The term “based on” indicates “at least partially based on.” The terms “one example” and “an example” indicate “at least one example.” The term “another example” indicates “at least one other example.” The terms “first,” “second,” etc. may refer to different or same objects. Other definitions, whether explicit or implied, may be included below. Unless explicitly stated in the context, the definition of one term is consistent throughout the description.

Solving partial differential equations (PDEs) is critical for a variety of industries. For example, solving PDEs can be used in engineering systems to optimize structures. For example, a static PDE problem may be defined in the form of:

$$in Ω , ℒ ( u ) = f \qquad ( 1 )$$

$$on {Γ}_{D} , u = {u}_{D}$$

$$on {Γ}_{n} , \frac{\partial u}{\partial n} = g$$

where [symbol] is a partial differential operator, e.g., an elliptic partial differential operator, and Γ_{D}∪Γ_{N}=∂Ω denotes the Dirichlet and Neumann boundaries, respectively. It can be assumed that all domains Ω are bounded orientable manifolds embedded in the ambient Euclidean space [symbol] n. It can be understood that the above static PDE problem is only an example, and the solution of the present application can also be applied to processing static PDE problems based on other models, as well as dynamic PDE problems (e.g., time-related PDE problems).

An NN model for PDE can be trained with training data to learn a mapping [symbol] : A→ [symbol] between two spaces, where [symbol] can be the solution space of the PDE and A can be the function space used to determine the solution of the PDE. Examples of A include PDE parameter functions used to define the PDE (e.g., which include coefficients (e.g., coefficient fields) and/or source terms), boundary conditions/initial conditions, or parameters used to define the shape in the domain.

According to various examples of the present application, in the training data, A for PDE can be generated without being limited to a specific PDE parameter function, boundary condition, or shape so that sufficient training data can be generated. The training data in various examples of the present application may be used to fully train the NN model and provide the NN model with good generalization capabilities. Accordingly, the geometric shapes in the domain Ω_{inf} used when performing inference with the NN model can be decoupled from the shapes in the domain Ωₜᵣₐᵢₙ used when training the NN model. In other words, the shapes in Ω_{inf} do not have to fall within or be similar to the shapes used during training but can be any shape.

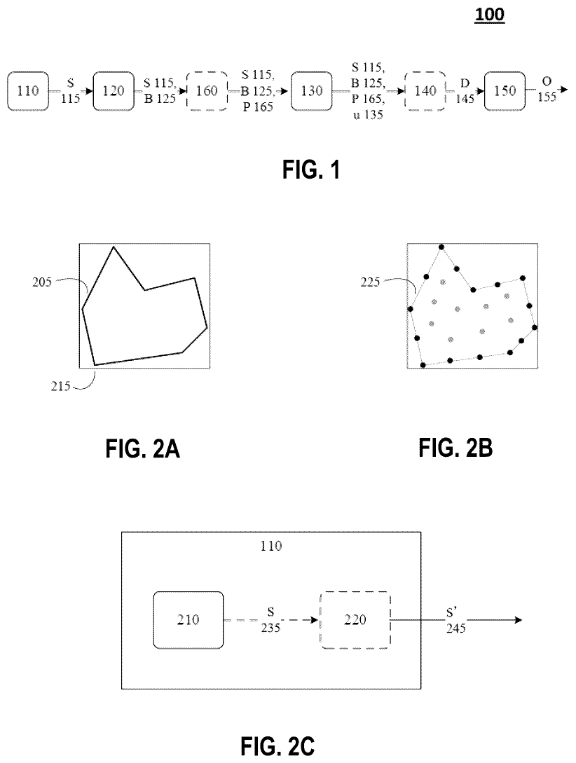

FIG. 1 shows a block diagram of an apparatus 100 for generating training data and training an NN model according to one example. In the example of FIG. 1, the apparatus 100 comprises a shape generation module 110, a boundary condition module 120, an (optional) PDE parameter function module 160, a solution module 130, an (optional) data augmentation module 140, and an NN model 150. It can be understood that the apparatus 100 may comprise other modules, and only the modules related to the examples of the present disclosure are shown in FIG. 1.

The shape generation module 110 may generate the basic shape S 115. In the examples of the present disclosure, when selecting basic shapes, it needs to be ensured that the NN model can solve the PDE problem for a variety of shapes. A probability space ( [symbol] , μ) may be specified, where μ represents a probability distribution over the shape space [symbol] . In one example, preferably, the generated basic shape satisfies two conditions: (1) Sampling feasibility: It should be easy to sample from μ and solve the boundary value problem on the shape in [symbol] in order to generate data for NN model learning; (2) full coverage: The basic shapes in [symbol] should flexibly cover any shape in the domain.

In one example, the domain Ω⊆ [symbol] ². A space [symbol] ₛ(n) of simple polygons with at most n vertices (i.e., planar polygons with no self-intersections and no holes) uniformly bounded by a certain region in [symbol] ² can be used. For example, the specific area may be the predetermined range 215 shown in FIG. 2A or may be another appropriate area. Simple polygons are Lipschitz domains with straightforward sampling methods and are flexible enough to constitute any discretized planar domain. It can be understood that any other basic shapes can also be generated, e.g., convex polygons, star polygons, etc., provided that the above two criteria are met.

FIG. 2A shows a schematic diagram of a basic shape 205 generated according to one example. In one example, the basic shape may comprise a planar polygon with no self-intersections and no holes. For example, the planar polygon may comprise n vertices (e.g., 3≤n≤12). For example, the basic shape 205 may be confined to a predetermined range 215. By way of example, the predetermined range 215 may be a unit square [0.5, 0.5]² ⊂ [symbol] ².

In one example, the basic shape may be a represented discretely. FIG. 2B shows a schematic diagram of a discretized basic shape 225 generated according to one example. For example, the basic shape may be discretized by sampling. The discretized basic shape may be represented by coordinate points on the edges (and inside) of the basic shape.

FIG. 2C shows a schematic diagram of a shape generation module 110 according to one example. In the example of FIG. 2C, the shape generation module 110 comprises a planar polygon generation module 210 and an optional sampling module 220. It can be understood that the shape generation module 110 may comprise other modules, and only the modules related to the examples of the present disclosure are shown in FIG. 2C.

The shape generation module 110 may generate the basic shape S 235 through the planar polygon generation module 210. For example, the number of vertices n may be specified to the planar polygon generation module 210, and the planar polygon generation module 210 may randomly generate a planar polygon S 235 comprising n vertices within a predetermined range.

For another example, the planar polygon generation module 210 may randomly determine the number of vertices n of the planar polygon and randomly generate a planar polygon S 235 comprising n vertices within a predetermined range. In one example, 3≤n≤12.

The shape generation module 110 may also optionally comprise a sampling module 220. For example, the sampling module can sample the basic shape S 235 generated by the planar polygon generation module 210 to generate a discrete basic shape S′ 245.

Referring back to FIG. 1, the shape generation module 110 may output the generated basic shape S 115 and the boundary condition module 120 may configure the basic shape S 115 with a boundary condition B 125 associated with the first PDE. According to examples of the present application, a boundary condition may be associated with a type of the boundary condition and a value range of the boundary condition and configuring the boundary condition associated with the first PDE for the boundary of the basic shape may include configuring the following items for the boundary of the basic shape:
(1) Type of boundary condition: The boundary of a basic shape can be configured with a single boundary condition or mixed boundary conditions. In the case of a single boundary condition, the entire boundary of the basic shape may be configured with the same type of boundary condition. In the case of mixed boundary conditions, the boundary of a basic shape may be configured with a plurality of types of boundary conditions. For example, different parts of the boundary of the basic shape can be configured with corresponding types of boundary conditions. In one example, the basic shape may be discretized, and configuring the type of boundary condition for the boundary of the basic shape may comprise configuring the type of boundary condition for discrete points on the boundary of the basic shape.
(2) Range of values for boundary conditions: The values of the boundary conditions for the basic shape can be in numerical form or in functional form. The reasoning process in the domain may encounter arbitrary ranges of values in boundary conditions, but it is often not feasible to include unbounded boundary condition values taken in the training data used to train the NN model. Therefore, value ranges of boundary conditions in the form of numerical values or functions can be configured in the training data. In one example, the basic shape may be discretized, and configuring the value range of the boundary condition for the boundary of the basic shape may comprise configuring the value range of the boundary condition for discrete points on the boundary of the basic shape.

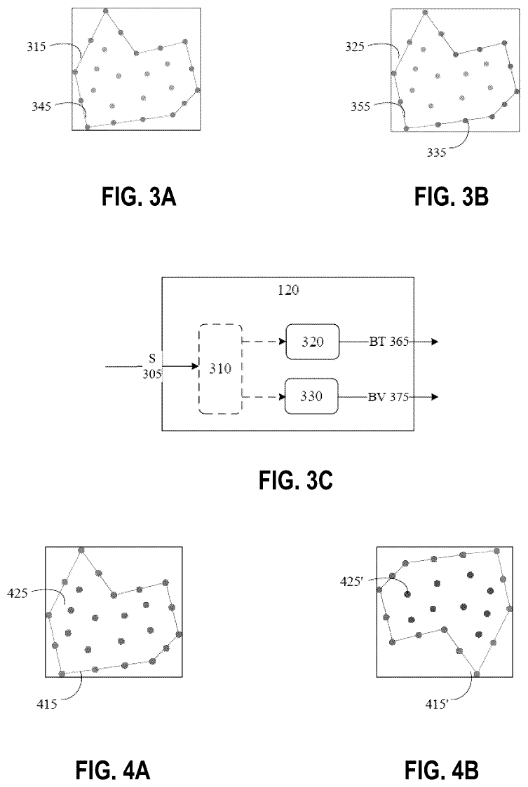

FIG. 3A shows a schematic diagram of a basic shape 345 configured with a single boundary condition according to one example. In one example, in the case of a single boundary condition, the entire boundary of the basic shape 345 may be configured with the same type of boundary condition 315. For example, the basic shape 345 may be discretized and a type of boundary condition may be configured for discrete points on the boundary of the basic shape 345. For example, the boundary condition may comprise one of a Dirichlet boundary condition, a Neumann boundary condition, and a Robin boundary condition. It can be understood that any other suitable type of boundary condition may be configured for the boundary of the basic shape.

FIG. 3B shows a schematic diagram of a basic shape 355 configured with mixed boundary conditions according to one example. In one case, in the case of mixed boundary conditions, the boundary of a basic shape 355 may be configured with a plurality of types of boundary conditions.

For example, the basic shape 355 may be discretized, and a plurality of types of boundary conditions may be configured for discrete points on the boundary of the basic shape 355. For example, the boundary of the basic shape may be partitioned into a first part and a second part, and a first type of boundary condition 325 may be configured for the first part of the basic shape 355 and a second type of boundary condition 335 may be configured for the second part of the basic shape 355. In one example, the first type of boundary condition may be a Dirichlet boundary condition and the second type of boundary condition may be a Neumann boundary condition. For example, the plurality of types of boundary conditions may comprise at least two of Dirichlet boundary conditions, Neumann boundary conditions, and Robin boundary conditions. It can be understood that a plurality of boundary conditions of any other suitable types may also be configured for the boundary of the basic shape.

FIG. 3C shows a schematic diagram of a boundary condition module 120 according to one example. In the example of FIG. 3C, the boundary condition module 120 comprises an optional partitioning module 310, a boundary condition type configuration module 320, and a boundary condition value configuration module 330. It can be understood that the boundary condition module 120 may comprise other modules, and only the modules related to the examples of the present disclosure are shown in FIG. 3C.

When a single boundary condition is configured for the boundary of the basic shape, there is no need to partition the boundary of the basic shape through the division module 310. When mixed boundary conditions are configured for the boundary of the basic shape, the partitioning module 310 may partition the boundaries of the basic shape S 115 into a plurality of parts. In one example, the partitioning module 310 may randomly partition the boundary of the basic shape S 115 into a plurality (e.g., two) of connected parts. The partitioning module 310 may output the partitioned parts to the boundary condition type configuration module 320 and the boundary condition value configuration module 330.

When a single boundary condition is configured for the boundary of the basic shape, the boundary condition type configuration module 320 can configure a type of boundary condition BT 365 for the boundary of the basic shape 305. For example, the Laplace2d-Dirichlet type PDE is a two-dimensional (2D) Laplace equation with a single Dirichlet boundary condition, which can be used to solve problems related to electric or magnetic field distribution for structural design or materials engineering problems of industrial products such as batteries (e.g., fuel cell bipolar plates), electrothermal devices, and electromagnets. For a Laplace2d-Dirichlet type PDE, the boundary condition type configuration module 320 may configure a single Dirichlet boundary condition for the basic shape. The Laplace2d-Dirichlet is constrained by the following equation:

$$in Ω , Δ u = 0 \qquad ( 2 )$$

$$on \partial Ω , u = uD$$

For another example, the Darcy2d type PDE is a 2D Darcy flow with a single Dirichlet boundary condition, a coefficient field a(x), and a source term f(x), which can be used to solve problems related to seepage (e.g., fluid velocity, pressure, etc.) for structural design or material engineering problems of industrial products such as hydraulic structures or water collection structures. For a Darcy2d type PDE, the boundary condition type configuration module 320 may configure a single Dirichlet boundary condition for the basic shape. The Darcy2d is constrained by the following equation:

$$in Ω , - ∇ ( a ( x ) ∇ u ) = f ( x ) \qquad ( 3 )$$

$$on \partial Ω , u = {u}_{0}$$

For another example, the Heat2d type PDE is a 2D time-varying heat conductivity equation with a coefficient α representing thermal diffusivity, time-varying boundary conditions, and initial conditions. It can be used to solve problems related to temperature distribution and is applicable to structural design or materials engineering problems of industrial products such as electric heaters, batteries, building material design, refrigeration, and insulation material design. For a Heat2d type PDE, the boundary condition type configuration module 320 may configure a Dirichlet boundary condition for the basic shape. The Heat2d is constrained by the following equation:

$$in Ω \times [ 0 , ⊤ ] , \frac{\partial u}{\partial t} = αΔ u \qquad ( 4 )$$

$$on \partial Ω \times [ 0 , ⊤ ] , u ( x , t ) = {u}_{D} ( x , t )$$

$$on Ω \times \{ 0 \} , u ( x , 0 ) = {u}_{0} ( x )$$

When hybrid boundary conditions are configured for the boundary of the basic shape, the boundary condition type configuration module 320 may configure a plurality of types of boundary conditions BT 365 for the boundary of the basic shape 305. For example, for each of the plurality of parts into which the basis shape is partitioned, the boundary condition type configuration module 320 may respectively configure one type of boundary condition from among a plurality of types of boundary conditions. For example, Laplace2d-Mixed type PDE is a 2D Laplace equation with mixed Dirichlet and Neumann boundary conditions on ∂Ω=Γ_{D}∪Γ_{N}, which can be used to solve problems related to electric field or magnetic field distribution for structural design or material engineering issues of industrial products such as batteries (e.g., fuel cell bipolar plates), electrothermal devices, and electromagnets. For a Laplace2d-Mixed type PDE, the boundary condition type configuration module 320 may configure Dirichlet and Neumann boundary conditions for different parts of the basic shape. The Laplace2d-Mixed is constrained by the following equation:

$$in Ω , Δ u = 0 \qquad ( 5 )$$

$$on {Γ}_{D} , u = {u}_{D}$$

$$on {Γ}_{N} , \frac{\partial u}{\partial n} = g$$

The values of the boundary conditions for the basic shape can be in numerical form or in functional form. The boundary condition value configuration module 330 can configure the boundary condition value BV 375 in the form of a numerical value or a function. For example, for the (partitioned) basic shape, the boundary condition value configuration module 330 may generate a random value within a predetermined range (e.g., within [0,1]) (e.g., by a random function) and the value of the boundary condition in numerical form or functional form can be based on the random value (e.g., equal to the random value, or a piecewise linear function determined by the random value, etc.).

In one example, the boundary condition module 120 may output the boundary condition B 125 configured for the basic shape, which includes a type of the boundary condition BT 365 and a value of the boundary condition BV 375.

Referring back to FIG. 1, optionally, the apparatus 100 may comprise a PDE parameter function module 160 that configures a PDE parameter function P 165 associated with the first PDE for the basic shape S 115. The PDE parameter function P 165 may include coefficients associated with the first PDE (e.g., coefficient field a(x) in Equation (3) and a in Equation (4)) and/or source terms (e.g., f(x) in Equation (4). In one example, the PDE parameter function module 160 can generate (e.g., by a random function) a random value within a predetermined range (e.g., within [0,1]) and the value of the PDE parameter function P 165 associated with the first PDE can be based on that random value (e.g., equal to the random value, or a piecewise linear function determined by the random value, etc.).

The apparatus 100 may comprise a solution module 130 that determines a solution u 130 of the first PDE for the basic shape based on the basic shape S 115 and the boundary condition B 125 (and optionally, the PDE parameter function P 165), wherein the solution u 130 represents the physical state of the object having the basic shape. In some examples, the solution module 130 may determine a solution u 130 for the basic shape by numerically solving the first PDE. For example, for the first PDE, a numerical solution method such as the finite element method (FEM) may be used to determine a solution u 130 of the basic shape. The first PDE may be a static PDE (e.g., Laplace2d-Dirichlet, Darcy2d, or Laplace2d-Mixed as described above, or any other static PDE) or a dynamic (e.g., time-varying) PDE (e.g., Head2d as described above, or any other dynamic PDE).

For example, in the case of a dynamic PDE, the solution may represent the physical state of the object with the basic shape over time. For example, the first PDE may be a time-varying PDE equation (e.g., Head2d as described above). In one example, the time-varying PDE equation may be constrained by the following equation:

$$in Ω \times [ 0 , T ] , {u}_{t} - ℒ u = f \qquad ( 6 )$$

$$on \partial Ω \times [ 0 , T ] , u ( x , t ) = {u}_{D} ( x , t )$$

$$on Ω \times \{ 0 \} , u ( x , 0 ) = {u}_{0} ( x )$$

where [symbol] is a partial differential operator, such as an elliptic partial differential operator. The method according to examples of the present disclosure can be applied to a dynamic PDE in the time-space dimension, such as that shown in Equation (6) above. For example, the method according to examples of the present disclosure can be applied to a dynamic PDE in the time-space dimension by decomposing the time-space domain Ω×[0, T]. The time-space domain decomposition can have the form Ωᵢ×[tⱼ₋₁−δ_{T}, tⱼ+δ_{T}], where δ_{T} is the temporal depth and represents the overlap in the temporal domain. After such a time-space domain decomposition is established, the method according to examples of the present disclosure can be applied to the time-space domain to obtain a global solution in the time-space domain. According to one example, iterations may be performed in parallel in the spatial and temporal domains. In one example of the PDE applied to heat dissipation, such as that shown in FIG. (8), a fixed time step ts and an extension length k can be used to discretize the time domain to time points t=0, tₛ, . . . , (k−1) tₛ. Accordingly, the solution u(x, 0), u(x, tₛ), . . . , u(x,(k−1)tₛ) of the solution module 130 may represent the physical state of an object having a basic shape at time t=0, tₛ, . . . , (k−1)tₛ.

FIG. 4A shows a schematic diagram of a solution 425 for a basic shape 415 determined according to one example. For example, the basic shape 415 may be discretized and the solution module 130 may determine: Under the constraints of the first PDE and its boundary conditions, the solution 425 at discrete points within the boundary of the basic shape 415.

According to aspects of the present application, in order to improve the generalization capability of the NN model, data augmentation may be performed to include more sufficient data in the training data (e.g., it can provide more sufficient information). The symmetry group of a general partial differential operator [symbol] refers to a set of transformations that map one solution to another. Symmetry can be used to generate a plurality of new solutions based on a given solution.

Referring back to FIG. 1, optionally, the apparatus 100 may comprise a data augmentation module 140 that may perform a data augmentation based on at least one of the basic shape S 115, the boundary condition values in the boundary condition B 125, the PDE parameter function P 165, and the solution u 135 to obtain at least one of a data-augmented basic shape, data-augmented boundary condition values, the data-augmented PDE parameter function, and the data-augmented solution. The training data D 145 is based on at least one of a data-augmented basic shape, a value of a data-augmented boundary condition, a data-augmented PDE parameter function, and a data-augmented solution and is obtained based on the basic shape, the boundary conditions, the PDE parameter function, and the solution.

In one example, the data augmentation module 140 may perform data augmentation based on the basic shape. For example, the data augmentation module 140 may perform at least one of spatial translation, spatial scaling, and/or spatial rotation on the basic shape to obtain a data-augmented basic shape.

For example, for any point X (x₁, x₂) in the basic shape S, spatial translation of the basic shape may encompass the transformation of point X: (x₁, x₂)→(x₁+t₁, x₂+t₂). Spatial rotation of the basic shape may encompass the transformation of point X: (x₁, x₂)→(x₁ cos θ−x₂ sin θ, x₁ sin θ+x₂ cos θ). Spatial scaling of the basic shape may encompass the transformation of point X: (x₁, x₂)→(sx₁, sx₂).

In one example, when spatial scaling is performed on the basic shape, the values of the boundary conditions, the solutions, and the PDE parameter functions in the boundary conditions can match the data-augmented basic shape without performing corresponding data augmentation (e.g., when the first PDE is a Laplace2d-Dirichlet type PDE described above with reference to Equation (2)) In one example, where spatial scaling is performed on the basic shape, the data augmentation module 140 may also perform data augmentation on least one of a value of the boundary condition, a solution, and a PDE parameter function in the boundary conditions so that the at least one of the value of the data-augmented boundary condition, solution, and PDE parameter function can match the data-augmented basic shape. For example, in the case of performing spatial scaling (x₁, x₂)→(sx₁, sx₂) on the basic shape, for the type Darcy2d PDE described above with reference to Equation (3), the data augmentation module 140 may also perform the following transformation (e.g., value scaling) on the coefficient field a(x) and source term f(x) in the solution u and boundary conditions u_{D} and the PDE parameter function: u→su, u_{D}→su_{D}, a(x)→a(x), f(x)→f(x); for the Heat2d type PDE described above with reference to Equation (4), the data augmentation module 140 may also perform the following transformations (e.g., value scaling) on the solution u, u₀, the boundary condition u_{D}, and the coefficient α in the PDE parameter function: u→u, u₀→u₀ u_{D}→u_{D}, a s²α; for the Laplace2d-Mixed type PDE described above with reference to Equation (5), the data augmentation module 140 may also perform the following transformation (e.g., value scaling) on the solution u and boundary conditions u_{D}, g: u→su, u_{D}→su_{D}, g→g.

For example, the data augmentation module 140 may perform data augmentation based on at least one of a value of a boundary condition, a PDE parameter function, and a solution. For example, the data augmentation module 140 may perform value offset and/or value scaling on at least one of a value of a boundary condition, a PDE parameter function, and a solution to obtain data-augmented values of the boundary conditions, data-augmented PDE parameter functions, and data-augmented solutions.

In one example, the data augmentation module 140 may perform value offset on the solution u and the boundary condition u_{D} by performing the following transformation on the solution u and the boundary condition u_{D}: u→u+t, u_{D}→u_{D}+t. In one example, the data augmentation module 140 may perform value scaling on the solution u and the boundary condition u_{D} by performing the following transformation on the solution u and the boundary condition u_{D}: u→su, u_{D}→su_{D}. In one example, for the Heat2d type PDE described above with reference to Equation (4), the data augmentation module 140 may also perform value scaling by performing the following transformation on the solution u, u₀ and the boundary condition u_{D}: u→su, u₀→su₀, u_{D}→su_{D}; for the Laplace2d-Mixed type PDE described above with reference to Equation (5), the data augmentation module 140 may also perform value scaling by performing the following transformation on the solution u and boundary conditions u_{D}, g: u→su, u_{D}→su_{D}, g→sg.

It will be understood that the various transformations and combinations above used to perform data augmentation are merely by way of example, and the data augmentation module 140 may also perform any other suitable data augmentation for any of the basic shape, values of boundary conditions, PDE parameter functions, and solutions.

FIG. 4B shows a schematic diagram of a data-augmented basic shape 415′ and solution 425′ according to one example. For example, the data-augmented basic shape 415′ may be obtained by performing spatial rotation on the basic shape 415, and the data-augmented solution 425′ may be obtained by performing value offset and/or value scaling on the solution 425. In another example, spatial rotation may also be performed only on the basic shape 415 to obtain a data-augmented basic shape 415′, while the solution 425 for the respective discrete points remains unchanged.

Referring back to FIG. 1, training data may be generated based on the examples described in the present application to train the NN model 150, which may be used to determine the physical state of an object having a shape.

The NN model 150 may comprise a neural network model of any appropriate structure. For example, the NN model 150 can adapt to flexible input/output formats and has sufficient expression capabilities to solve local problems with randomly varied shapes and PDE parameter functions. For example, the NN model 150 may comprise neural network models such as GNOT, FNO, and DeepONet.

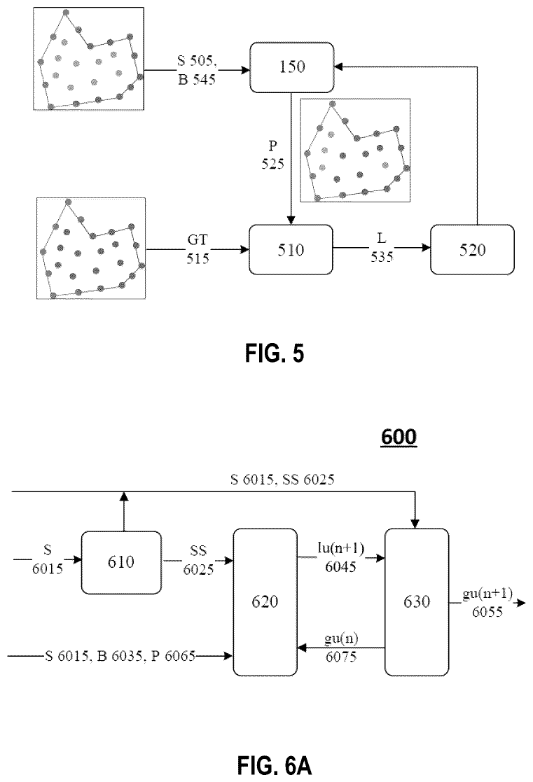

FIG. 5 shows a schematic diagram for training the NN model 150 according to one example. FIG. 5 shows the NN model 150, the loss module 510, and the update module 520. It can be understood that other modules may also be included, and only the modules related to the examples of the present disclosure are shown in FIG. 5.

The NN model 150 can predict a solution P 525 for the basic shape based on the basic shape S 505 and boundary condition B 545 in the training data D 145 generated according to the method described in the present application, wherein the solution P 525 represents the physical state of an object having the basic shape. The loss module 510 may comprise any suitable loss function, including an L1 Loss function, an MSELoss function, or a cross-entropy function, among others. The loss module 510 may determine the loss L 535 based on the solution P 525 predicted by the NN model and the solution GT 515 in the training data. The update module 520 may update the learnable parameters of the NN model 150 based on the loss L 535. It can be understood that any appropriate optimization method may be employed to update the learnable parameters of the NN model.

By training the NN model 150 using the training data described in the present application, the NN model 150 is able to learn to solve for the basic shape. In particular, where the training data includes data that has been augmented, the NN model 150 can be more fully trained to capture complex details and variations in the basic shape.

When determining the physical state of an object having a shape, the shape of the object may be relatively complex. The present application proposes a novel Schwarz neural inference (SNI) method and apparatus that first partitions (e.g., relatively complex) shapes into a plurality of sub-shapes; then applies the NN model to each sub-shape to obtain a local solution for that sub-shape; and obtains a global solution for the shape based on the local solution for each sub-shape. This local-to-global approach of SNI enables the NN model for the first PDE to solve the PDE problem and determine the physical state of objects with arbitrary shapes (and not limited to the particular shape used in the training phase) during the inference phase, thereby greatly increasing the efficiency of the use of the NN model in practical industrial applications.

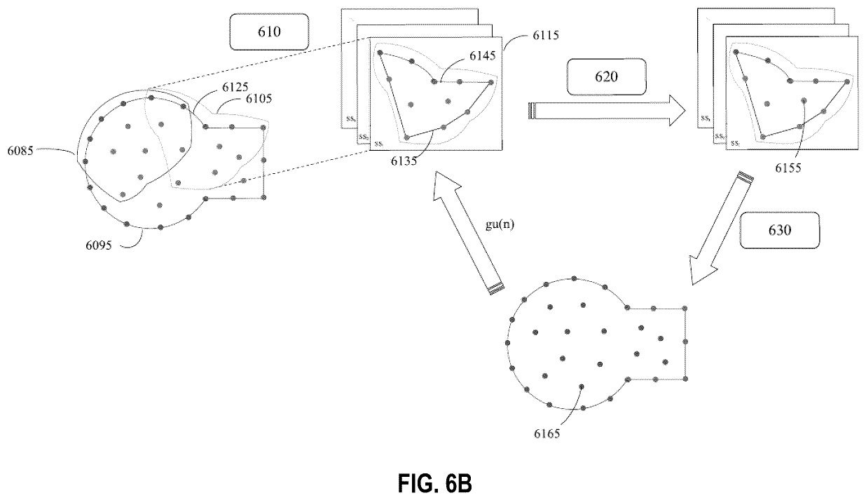

FIG. 6A shows a block diagram of an apparatus 600 for determining the physical state of an object having a shape according to one example. In the example of FIG. 6A, the apparatus 600 comprises a partitioning module 610, a local solution module 620, and a global solution module 630. It can be understood that the apparatus 600 may comprise other modules, and only the modules related to the examples of the present disclosure are shown in FIG. 6A.

The partitioning module 610 can partition the shape S 6015 of an object into a plurality of sub-shapes SS 6025, wherein the full set of the plurality of sub-regions corresponding to the plurality of sub-shapes SS 6025 covers the complete area of the shape S 6015. For example, the partitioning module 610 may partition the shape S 6015 into a plurality of sub-shapes SS 6025 based on the data of the shape S 6015 used to represent the object in the structural data. In one example, the shape of the object in the structural data is represented by at least one of the following: center of circle, radius, width, height, length, grid, discrete points, or geometric shapes.

Referring to the example in FIG. 6B, the object may have a shape 6095 and the partitioning module 610 may partitioning the shape 6095 into a plurality of (e.g., K, K being an integer greater than 1) sub-shapes SS₁, SS₂, . . . SS_{K}. For simplicity, only two sub-shapes 6085 and 6105 are shown in FIG. 6B. Each of the plurality of sub-shapes may each be within a predetermined range. For example, the sub-shape 6105 may be within the range 6115.

In the present application, the boundary of the shape of the object may be referred to as the global boundary, and the boundary of a sub-shape may be referred to as a local boundary. Referring to the example in FIG. 6B, in one example, the boundary of the shape 6095 may be associated with a global boundary condition 6125 (e.g., shown by the red and green portions in FIG. 6B). Accordingly, at least some of the plurality of sub-shapes that are partitioned may be associated with a partial global boundary condition in the global boundary condition 6125. For example, the sub-shape 6105 may be associated with a partial global boundary condition 6145 in the global boundary condition 6125 (e.g., shown by red and green portions in SS₁). The values of the partial global boundary condition 6145 of the sub-shape 6105 may be identical to the value of the portion of the global boundary condition 6125 of the shape 6095 corresponding to the sub-shape 6105.

In one example, the boundary of the sub-shape 6105 may be associated with a virtual boundary condition 6135 (e.g., shown by the gray portion in SS₁). For example, the virtual boundary condition 6135 of the sub-shape may be a boundary condition in the boundary of the sub-shape 6105 that does not belong to the boundary of the shape 6095. For example, the virtual boundary condition 6135 of the sub-shape may include a boundary condition on a boundary consisting of points inside the shape (e.g., not at the boundary of the shape). In one example, the local and global solution for each sub-shape is obtained by a plurality of rounds of iteration, and the value of the virtual boundary condition 6135 of the sub-shape in the n+1 round may be based on the global solution gu(n) for the shape 6095 in the previous round.

In one example, the local boundary conditions of a sub-shape may include partial global boundary conditions and/or virtual boundary conditions for the sub-shape. For example, the local boundary condition of sub-shape 6105 may include the partial global boundary condition 6145 and virtual boundary condition 6135.

The local solution module 620 may obtain a local solution for each of the plurality of sub-shapes SS 6025 based on the global boundary condition B 6035 for the shape S 6015 and the plurality of sub-shapes SS 6025 (and the PDE parameter function 6065, if applicable) through a neural network (NN) model, and the local solution for each sub-shape represents the local physical state of the object with the sub-shape. The data used to represent the shape S 6015 of the object, the global boundary condition B 6035, and the optional PDE parameter function 6065 may be referred to as structural data, which represents the structure of the object and the constraints of the physical system with which it complies. In one example, the local solution and global solution for each sub-shape are obtained by a plurality of rounds of iteration, and the local solution module 620 may also obtain the local solution lu(n+1) of the n+1th round 6045 based on the global solution of the nth round gu(n) 6075. For example, the global solution gu(0) may be initialized before entering the first round of local solution. For example, the global solution gu(0) may be set to a default value (e.g., 0 or 1) or randomly initialized.

For example, the local solution module 620 may obtain a local solution for each sub-shape of the plurality of sub-shapes through the NN model based on each sub-shape and the local boundary conditions for each sub-shape. For example, for the sub-shape 6105, the local solution module 620 may obtain a local solution for the points inside the sub-shape 6105 (e.g., shown by light blue dots) via the NN model based on the sub-shape 6105 and its associated local boundary conditions. While the light blue dots inside the shape 6105 are utilized in the FIG. 6B to represent the NN model obtaining a local solution for the internal points of the sub-shape 6105, in another example, the NN model may determine a local solution for all points on the sub-shape 6105 (including the local boundary points and internal points) based on the shape 6105 and its associated local boundary conditions. During the iteration process, the value on the global boundary remains unchanged, while the value on the virtual boundary is updated in each iteration.

Returning to FIG. 6A, the global solution module 630 in the apparatus 600 may obtain a global solution for the shape based on the local solution for each sub-shape of the plurality of sub-shapes, and the global solution for the shape represents the physical state of the object. In one example, the local solution and global solution for each sub-shape are obtained by a plurality of rounds of iteration, and the global solution gu(n+1) 6055 of the n+1th round may be based on the local solution lu(n+1) 6045 for each sub-shape.

Referring to the example in FIG. 6B, the global solution module 630 may extend and concatenate the local solutions for each sub-shape to obtain a global solution 6165 for the shape 6095 (e.g., shown by the dark blue dots in FIG. 6B).

In one example, during the inference process, the PDE associated with the shape may be a dynamic PDE. Accordingly, the solution for the shape represents the physical state of the object with the shape over time. In one example, the object may be at least one of a fuel cell bipolar plate, a part of a car, a part of an airplane, a part of a building, a pipe of a reactor, and a guide plate, and wherein the physical state comprises at least one of velocity, pressure, temperature, electric field, and magnetic field.

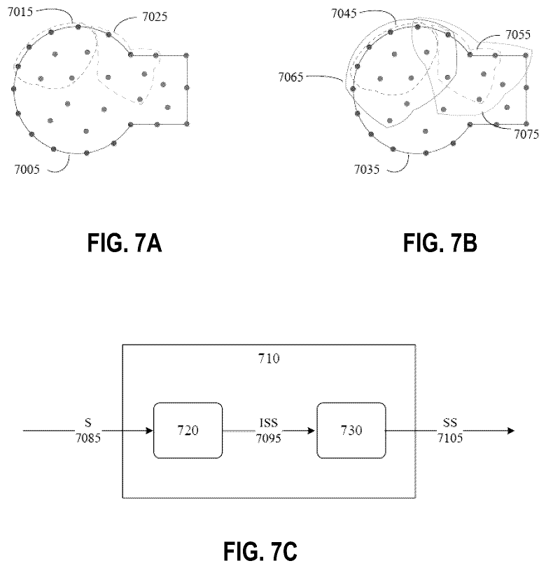

In one example, the partitioning module 610 may comprise a non-overlapping partitioning module that partitions a shape into a plurality of non-overlapping sub-shapes to form a plurality of non-overlapping sub-shapes, the full set of the corresponding plurality of sub-regions of the plurality of sub-shapes covering the complete area of the shape. FIG. 7A shows a schematic diagram of partitioning a shape into a plurality of non-overlapping sub-shapes according to one example. For example, for simplicity, only two of the plurality of non-overlapping sub-shapes 7015 and 7025 are shown in FIG. 7A. In examples where the shapes are discretized, any two of the non-overlapping sub-shapes may not include overlapping points. The partitioning module 610 may partition the shape into K non-overlapping sub-shapes based on a graph partitioning algorithm such as METIS, where K is an integer greater than 1. In one example, K may be preset, e.g., K may be a hyperparameter.

In one example, the partitioning module 610 may comprise an overlapping partitioning module that partitions a shape into a plurality of overlapping sub-shapes to form a plurality of overlapping sub-shapes, the full set of the corresponding plurality of sub-regions of the plurality of sub-shapes covering the complete area of the shape. In examples where the shapes are discretized, at least two of the overlapping sub-shapes may include overlapping points. For example, overlapping partitioning of shapes may facilitate convergence of SNI-based methods in examples of the present disclosure to more accurately determine the physical state of an object having a shape.

FIG. 7C shows a schematic diagram of an overlapping partitioning module 710 according to one example. In the example of FIG. 7C, the overlapping partitioning module 710 comprises an intermediate partitioning module 720 and a shape extension module 730. It can be understood that the overlapping partitioning module 710 may comprise other modules, and only the modules related to the examples of the present disclosure are shown in FIG. 7C.

The intermediate partitioning module 720 may partition the shape S 7085 into a plurality of non-overlapping sub-shapes to form a plurality of non-overlapping intermediate sub-shapes ISS 7095. In one example, the intermediate partitioning module 720 may comprise the above-described non-overlapping partitioning module and the full set of the plurality of sub-regions corresponding to the plurality of intermediate sub-shapes ISS 7095 covers the complete area of the shape. In one example, the full set of the plurality of sub-regions corresponding to the non-overlapping intermediate sub-shape ISS 7095 partitioned by the intermediate partitioning module 720 may not cover the entire area of the shape, and thus the plurality of non-overlapping intermediate sub-shapes may differ from the plurality of non-overlapping sub-shapes. In examples where the shape S 7085 is discretized, any two of the plurality of non-overlapping intermediate sub-shapes may not include overlapping points, and at least one point in the shape may not be included in any intermediate sub-shape.

Referring to FIG. 7B, the intermediate partitioning module 720 may partition the shape 7035 into a plurality of non-overlapping intermediate sub-shapes. For simplicity, FIG. 7B shows only the first and second intermediate sub-shapes 7045 and 7055 of the plurality of intermediate sub-shapes.

Referring back to FIG. 7C, the overlapping partitioning module 710 may comprise a shape extension module 730 to extend some or all of the plurality of non-overlapping intermediate sub-shapes to form a plurality of overlapping sub-shapes. For example, in examples where the shape is discretized, for some or all of the plurality of intermediate sub-shapes, the shape extension module 730 may iteratively include neighboring points in the intermediate sub-shape to form a plurality of overlapping sub-shapes. In one example, the iteration may be performed for d rounds, where d may be referred to as the extension depth d and is preset, e.g., d may be a hyperparameter. In another example, the iteration may be performed until the full set of the plurality of sub-regions corresponding to the overlapping plurality of sub-shapes covers the entire area of the shape.

Referring to FIG. 7B, the shape extension module 730 may extend the first intermediate sub-shape 7045 onto a first sub-shape 7065 and the second intermediate sub-shape 7055 into a second sub-shape 7075.

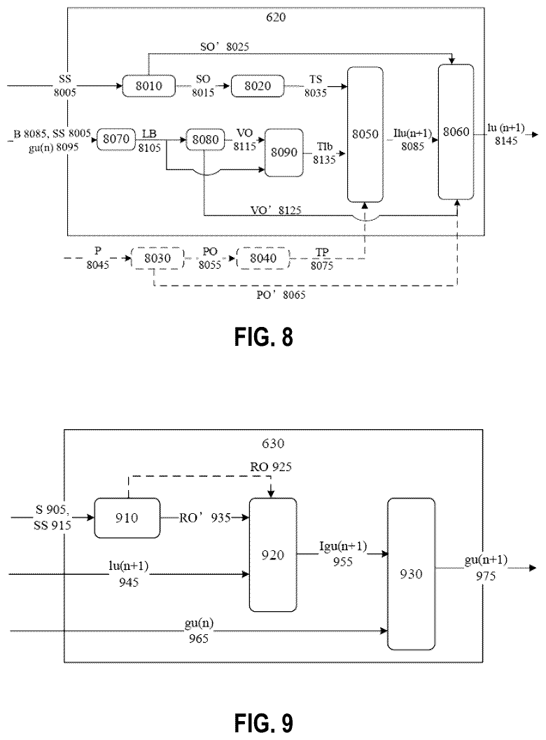

FIG. 8 shows a schematic diagram of a local solution module 620 according to one example. According to the example of FIG. 8, the local solution module 620 may comprise a sub-shape operator generation module 8010, a sub-shape preprocessing module 8020, an NN model 8050, a post-processing module 8060, a local boundary condition module 8070, a value operator generation module 8080, and a value preprocessing module 8090. FIG. 8 also shows an optional PDE parameter function operator generation module 8030 and an optional PDE function parameter preprocessing module 8040 outside of the local solution module 620. In one example, the PDE parameter function operator generation module 8030 and the PDE function parameter preprocessing module 8040 may also be included within the local solution module 620. It can be understood that the local solution module 620 may comprise other modules, and only the modules related to the examples of the present disclosure are shown in FIG. 8.

The range of sub-shapes and boundary conditions may differ from the range of the training data (e.g., training data generated according to the method described in the examples of the present disclosure) during inference on any partitioned sub-shapes. In order for the NN model trained based on the training data to be better adapted to the partitioned sub-shapes during the inference phase, the transformation T: P×H→P×H can be applied to convert local problems whose shapes or values are outside the range of the training data into the range of the training data, where P represents the space of the sub-shapes and H represents boundary conditions and optional PDE function parameters. The transformation T may be referred to as preprocessing in the examples of the present disclosure. For example, preprocessing may comprise at least one of: Spatial translation, spatial scaling, value offset, and value scaling, where spatial translation and spatial scaling may be applied to sub-shapes, and value offset and value scaling may be applied to PDE parameter functions and/or local boundary condition values. After inference through the NN model G: P×H→U, the resulting solution function can be transformed back through the appropriate inverse transformation T̆:U→U. The transformation may not be referred to as post-processing in the examples of the present disclosure. In examples where the range of the sub-shapes and boundary conditions may be the same as the range of the training data, the above preprocessing and post-processing of the sub-shapes and boundary conditions may not be performed, and preprocessing transformations and post-processing transformations may be determined or default preprocessing operators and post-processing operators may be used, which do not actually transform the sub-shapes and boundary conditions. For example, the preprocessing operator/post-processing operator may include a sub-shape preprocessing operator/processing operator, a PDE parameter function preprocessing operator/processing operator, and a value preprocessing operator/processing operator.

For each of the plurality of sub-shapes SS 8005, the sub-shape operator generation module 8010 may obtain the sub-shape preprocessing operator SO 8015 and the sub-shape post-processing operator SO′ 8025 based on the sub-shape. For example, the range of the sub-shape (e.g., the range 6115 in FIG. 6B for the sub-shape 6105) may be outside the predetermined range of the basic shape in the training data (e.g., 215 in FIG. 2A), and the sub-shape operator generation module 8010 can determine the sub-shape preprocessing operator SO 8015 and the sub-shape post-processing operator SO′ 8025 based on the range 6115 of the sub-shape and the predetermined range of the basic shape 215. For example, the sub-shape preprocessing operator SO 8015 may correspond to a spatial translation and/or spatial scaling of the sub-shape for transforming the range 6115 of the sub-shape to within the predetermined range 215, and the sub-shape post-processing operator SO′ 8025 may be an inverse transformation corresponding to the sub-shape preprocessing operator SO 8015. For example, the predetermined range 215 of the basic shape is the unit square [0.5, 0.5]² ⊂ [symbol] ² the range 6115 of the sub-shape is [0, 2]×[0, 2], the sub-shape preprocessing operator SO 8015 can correspond to a spatial shift of [−1, −1] and a spatial scaling of 0.5, and the corresponding sub-shape post-processing operator SO′ 8025 can correspond to a spatial shift of [+1, +1] and a spatial scaling of 2, so that the preprocessed sub-shape is transformed to within the predetermined range of the basic shape as the training data.

Accordingly, for each of the plurality of sub-shapes SS 8005, the sub-shape preprocessing module 8020 may apply the obtained sub-shape preprocessing operator SO 8015 to the sub-shape to obtain the preprocessed sub-shape TS 8035. For example, in examples where the shape is discretized, for any point X(x₁, x₂) in the sub-shape, performing spatial translation on the sub-shape may comprise transforming the point X: (x₁, x₂)→(x₁+t₁, x₂+t₂), and performing spatial scaling on the sub-shape may comprise transforming the point X: (x₁, x₂)→(sₓ, sx₂) or (x₁+t₁, x₂+t₂)→(s(x₁+t₁), s(x₂+t₂)). In one example, the NN model 8050 can obtain an intermediate value for a local solution for each sub-shape of a plurality of sub-shapes based on the preprocessed sub-shape TS 8035. In example, the post-processing module 8060 may apply the sub-shape post-processing operator SO′ 8025 to the intermediate value of the local solution to obtain a local solution for each of the plurality of sub-shapes. For example, the post-processing module 8060 may apply the sub-shape post-processing operator SO′ 8025 to the preprocessed sub-shape TS 8035 to transform it back to the original range of the sub-shape 8005 to obtain a local solution for each of the plurality of sub-shapes. It can be understood that the above transformations are by way of example only, and that any other appropriate transformations may be applied to preprocess/post-process sub-shapes.

For example, the local solution for each sub-shape and the global solution for the shape can be obtained through a plurality of rounds of iteration, and the intermediate value of the local solution for the current (n+1)th round can be expressed as llu(n+1) 8085, where llu(n+1) 8085 can include the intermediate value of the local solution for each sub-shape in the plurality of sub-shapes, and the local solution of the sub-shape can be expressed as lu(n+1) 8145, where lu(n+1) 8145 can include the local solution for each sub-shape in the plurality of sub-shapes.

Where there is a PDE parameter function in the structural data, the PDE parameter function operator generation module 8030 may obtain the PDE parameter function preprocessing operator PO 8055 and the PDE parameter function post-processing operator PO′ 8065 based on the PDE parameter function P 8045. By way of example, the value range of the PDE parameter function (e.g., PDE parameter function 6065) in the structural data (e.g., the value range of coefficients (such as coefficient fields) and/or source terms (e.g., maximum and/or minimum values)) may be outside the value range of the PDE parameter function in the training data (e.g., [0,1]), and the PDE parameter function operator generation module 8030 can determine the PDE parameter function preprocessing operator PO 8055 and the PDE parameter function post-processing operator PO′ 8065 based on the value range of the PDE parameter function in the structural data and the value range of the PDE parameter function in the training data. For example, the PDE parameter function preprocessing operator PO 8055 may correspond to a value offset and/or value scaling for transforming the value range of the PDE parameter function in the structural data to the value range of the PDE parameter function in the training data, and PDE parameter function post-processing operator PO′ 8065 may be a an inverse transformation corresponding to the PDE parameter function preprocessing operator PO 8055.

Accordingly, the PDE parameter preprocessing module 8040 can apply the obtained PDE parameter function preprocessing operator PO 8055 to the PDE parameter function in the structural data to obtain the preprocessed PDE parameter function TP 8075. For example, for coefficient α (or coefficient field a(x)) and/or source term f(x) in the PDE parameter function, the value offset may comprise the transformation: α→α+t, a(x)→a(x′), f(x)→f(x′), and the value scaling can comprise the transformation: α→sα, a(x)→a(x′), f(x)→f(x′). For example, in examples where the shape is discretized, x and x′ the coordinates of the point in the above-mentioned sub-shape 8005 and the coordinates of the corresponding point in the preprocessed sub-shape TS 8035. In one example, the NN model 8050 can obtain an intermediate value llu(n+1) 8085 for a local solution for each sub-shape of a plurality of sub-shapes based on the preprocessed PDE parameter function TP 8075. In one example, the post-processing module 8060 may apply the PDE parameter function post-processing operator PO′ 8065 to the intermediate values of the local solution to obtain a local solution lu(n+1) 8145 for each sub-shape of the plurality of sub-shapes. It can be understood that the above transformations are by way of example only, and that any other appropriate transformations may be applied to preprocess/post-process PDE parameter functions.

For each of the plurality of sub-shapes SS 8005, the local boundary condition module 8070 may set local boundary condition LB 8105 for the sub-shape based on at least one of the global boundary condition B 8085 and the global solution gu(n) 8095 of the previous round for the shape. For example, for each of the plurality of sub-shapes SS 8005, the local boundary condition module 8070 may determine that the local boundary of the sub-shape is associated with only a portion of the global boundary and accordingly set the local boundary condition LB 8105 of the sub-shape to the boundary condition value at the portion of the boundary in the global boundary condition B 8085; alternatively, the local boundary condition module 8070 may determine that the local boundary of the sub-shape is associated with only a virtual boundary (e.g., the virtual boundary does not belong to the global boundary of the shape and may be inside the shape) and accordingly set the local boundary condition LB 8105 of the sub-shape to the global solution value at the virtual boundary in the global solution gu(n) 8095; or alternatively, the local boundary condition module 8070 may determine that: the local boundary of the first portion of the sub-shape is associated with the global boundary of the first portion, the local boundary of the second portion of the sub-shape is associated with the virtual boundary of the second portion, the first local boundary condition in the local boundary conditions LB 8105 of the sub-shape can be set to the boundary condition value at the global boundary of the first portion in the global boundary condition B 8085, and the second local boundary condition in the local boundary conditions LB 8105 of the sub-shape can be set to the global solution value at the virtual boundary of the second portion in the global solution gu(n) 8095.

In one example, the local solution for each of the plurality of sub-shapes is determined based on local boundary conditions for the sub-shape and the sub-shape.

For each of the plurality of sub-shapes SS 8005, the value operator generation module 8080 may obtain the value preprocessing operator VO 8115 and the value post-processing operator VO′ 8125 for the sub-shape based on the local boundary condition LB 8105 for the sub-shape. For example, for each of the plurality of sub-shapes SS 8005, the value range for the local boundary condition LB 8105 of the sub-shape (e.g., based on its maximum and/or minimum value) may be outside the predetermined range (e.g., [0, 1]) of the boundary conditions in the training data, and the value operator generation module 8080 may determine the value preprocessing operator VO 8115 and the value post-processing operator VO′ 8125 based on the value range of the local boundary condition LB 8105 (e.g., based on its maximum and/or minimum value) and the predetermined range of the boundary conditions in the training data. For example, the value preprocessing operator VO 8115 may correspond to a value offset and/or value scaling used to transform the value range of the local boundary condition LB 8105 to within a predetermined range of the boundary conditions in the training data, and the post-processing operator VO′ 8125 may be an inverse transform corresponding to the value preprocessing operator VO 8115.

For each of the plurality of sub-shapes SS 8005, the value preprocessing module 8090 may apply a value preprocessing operator VO 8115 to the local boundary condition LB 8105 to obtain the preprocessed local boundary condition Tlb 8135. For example, the value offset of the value b in the local boundary condition LB 8105 may comprise a transformation: b→b+t, and the value scaling of the value b in the local boundary condition LB 8105 may comprise a transformation: b→sb or b+t→s(b+t). It can be understand that the above transformation are by way of example only, and any other appropriate transformations may be applied to preprocess/post-process the values in the local boundary condition LB 8105.

In one example, the NN model 8050 can obtain an intermediate value llu(n+1) 8085 of a local solution for each of the plurality of sub-shapes based on the preprocessed sub-shape TS 8035 and the preprocessed local boundary condition Tlb 8135 (and the preprocessed PDE parameter function TP 8075, if present). In one example, the post-processing module 8060 may apply a post-processing operator VO′ 8125 to the intermediate values of the local solution to obtain a local solution lu(n+1) 8145 for each of the plurality of sub-shapes. In one example, when the PDE parameter function TP 8045 is included in the structural data, only the PDE parameter function preprocessing operator PO 8055 can be generated without generating the PDE parameter function post-processing operator PO′ 8065. Accordingly, the post-processing module 8060 does not need to consider the PDE parameter function post-processing operator PO′ 8065.

In one example, the NN model 8050 can be trained according to the method described herein. For example, the NN model 8050 may be trained based on training data generated by the method described herein.

FIG. 9 shows a schematic diagram of a global solution module 630 according to one example. In the example of FIG. 9, the global solution module 630 may include a restriction and extension operator generation module 910, a concatenation module 920, and an update module 930. It can be understood that the global solution module 630 may comprise other modules, and only the modules related to the examples of the present disclosure are shown in FIG. 9.

The restriction and extension operator generation module 910 may obtain a restriction operator and extension operator for each sub-shape based on each sub-shape of the plurality of sub-shapes SS 915. For example, for each of the plurality of sub-shapes SS 915, the restriction and extension operator generation module 910 can determine which part of the shape S 905 the sub-shape SS 915 is associated with (for example, which discrete points in the shape the sub-shape includes) and accordingly determine the restriction operator RO 925 for restricting the area of shape S 905 to the area of the sub-shape SS 915 and the extension operator RO′ 935 for extending from the area of the sub-shape SS 915 to the area of shape S 905. For example, the restriction operator RO 925 and the extension operator RO′ 935 can be mutually transposed matrices, where the matrix dimension (number of rows and columns) of the extension operator RO′ 935 are the total number of points on the shape S 905 and the local number of points on the sub-shape SS 915, respectively. The elements in the matrix corresponding to the position points of the sub-shape SS 915 are set to 1 and the other elements are set to 0, so that by multiplying the matrix with the solution vector of the sub-shape SS 915, the solution vector of the sub-shape SS 915 can be extended to the dimensions of the solution vector of the shape S 905. On the other hand, transposing of the matrix of the extension operator RO′ 935 can serve as the restriction operator RO 925.

For example, the area of shape S 905 may be a square [−1, 1]², and the region of the first sub-shape SS 915 of the plurality of sub-shapes partitioned from the shape may be a square [−1, 0]². Accordingly, the restriction and extension operator generation module 910 may determine the restriction operator RO 925 for the first sub-shape such that by applying the restriction operator RO 925 to the values on the region of the shape [−1,1]², a first sub-shape in the region [−1, 0]² may be obtained, and it has the value of a portion corresponding to the region [−1, 0]² of the first sub-shape SS 915 among the values of the shape S 905. The restriction and extension operator generation module 910 may also determine the extension operator RO′ 935 for the first sub-shape SS 915 such that by applying the extension operator RO′ 935 to the values on the region [−1, 0]² of the first sub-shape SS 915, an extended sub-shape covering the region ([−1, 1]²) of the shape S 905 can be obtained, in which the extended sub-shape has the same value as the first sub-shape SS 915 in the region [−1, 0]² and can have a default value (e.g., 0) in the other parts of the region [−1, 1]² excluding the region of the first sub-shape SS 915.

In one example, the concatenation module 920 can obtain the intermediate value lgu(n+1) 955 of the global solution for the shape S 905 based on the local solution lu(n+1) 945 for each sub-shape SS 915 and the extension operator RO′ 935 for each sub-shape SS 915. For example, for a sub-shape k among the K sub-shapes SS 915 partitioned from the shape S 905, the concatenation module 920 may apply the extension operator ROₖ′ 935 for the sub-shape k to the local solution lu(n+1)k 945 for the sub-shape (e.g., RO′ₖ(lu(n+1)ₖ)), and the concatenation module 920 may sum the extended local solutions RO′ₖ(lu(n+1)ₖ) for each sub-shape k to obtain an intermediate value lgu(n+1) 955 of the global solution of the shape

$$( e . g . , Igu ( n + 1 ) = {\sum }_{k = 1}^{K} {RO}^{′} k ( {lu ( n + 1 )}_{k} ) ) .$$

In another example, the concatenation module 920 may obtain an intermediate value lgu(n+1) 955 of the global solution for the shape S 905 based on the local solution lu(n+1) 945 for each sub-shape SS 915, the extension operator RO′ 935 and the restriction operator RO 925 for each sub-shape SS 915, and the global solution gu(n) of the previous round for the shape S 905

$$( e . g . , Igu ( n + 1 ) = {\sum }_{k = 1}^{K} {RO}^{′} k ( {lu ( n + 1 )}_{k} ) + ( I - {RO}_{k}^{′} {RO}_{k} ) gu ( n ) ) ,$$

wherein l is an identity matrix). In this example, for each sub-shape k, RO′ₖ(lu(n+1)ₖ)+(I−RO′ₖROₖ)gu(n) indicates that within the entire region of the shape, the solution on the subdomain of the sub-shape k is lu(n+1)ₖ and the solution on the subdomain outside the sub-shape k is gu(n).

The update module 930 can obtain the global solution gu(n+1) 975 for the shape based on the intermediate value lgu(n+1) 955 of the global solution for shape S 905 and the global solution gu(n) of the previous round for the shape S 905.

For example, the update module 930 may obtain the global solution gu(n+1) 975 for the shape S 905 based on a linear combination of the intermediate value lgu(n+1) 955 of the global solution for the shape S 905 and the global solution gu(n+1) 975 of the previous round for the shape S 905. For example, the update module 930 may calculate the global solution gu(n+1) 975 for the shape S 905 by:

$$gu ( n + 1 ) = ( 1 - τ K ) gu ( n ) + τ Igu ( n + 1 ) \qquad ( 7 )$$

wherein K is the number of sub-shapes, τ is the step length, which is a hyperparameter used to control the convergence rate, and 0<τ<1. K

According to examples of the present disclosure, the SNI operation described herein may be performed based on the following Algorithm 1:

TABLE 1
Algorithm 1

```
Algorithm 1: Schwarz neutral inference (SNI)
Input: Shape S; global boundary condition B; PDE parameter function P; number of sub-
shapes K; extension depth d; mapping [symbol]  of the NN model; step length τ; convergence
criterion C;
Output: Global solution gu;
1. Apply METIS and d-based shape extension to obtain overlapping sub-shapes {SSₖ} Kk =
1, obtain the restriction operator
  $\{ {\{ {RO}_{k} \}}_{k = 1}^{K} and extension operator \{ {\{ {RO}_{k}^{′} \}}_{k = 1}^{K} ;$
2. Initialize global solution gu(0);
3. while convergence criterion C is not met do
4. Using the global boundary condition B and the global solution gu(n) from the previous
$round , set the local boundary condition {\{ {B}_{k} \}}_{k = 1}^{K} ;$
$5. Obtain the preprocessing operator {\{ {T}_{k} \}}_{k = 1}^{K} and the post - processing operator {\{ {\check{T}}_{k} \}}_{k = 1}^{K} ;$
6. Using the NN model, perform inference for each sub-shape: lu(n + 1)ₖ = Ťₖ ∘ [symbol]   ∘ Tₖ
(SSₖ, Bₖ)
7. Extend and concatenate local solutions:
        $Igu ( n + 1 ) = {\sum }_{k = 1}^{K} {RO}^{′} k ( {lu ( n + 1 )}_{k} ) + ( I - {RO}_{k}^{′} {RO}_{k} ) gu ( n ) ;$
8. Update the global solution: gu(n + 1) = (1 − τK)gu(n) + τ Igu(n + 1);
9. n = n + 1;
10. end while
11. return gu(n);
```

In Algorithm 1 of Table 1, the shape S may also be expressed as a domain Ω and the sub-shape SSₖ may be expressed as sub-domain Ωₖ. In one example, the convergence criterion C may be gu(n+1) that no longer changes or the amount of change is less than the threshold.

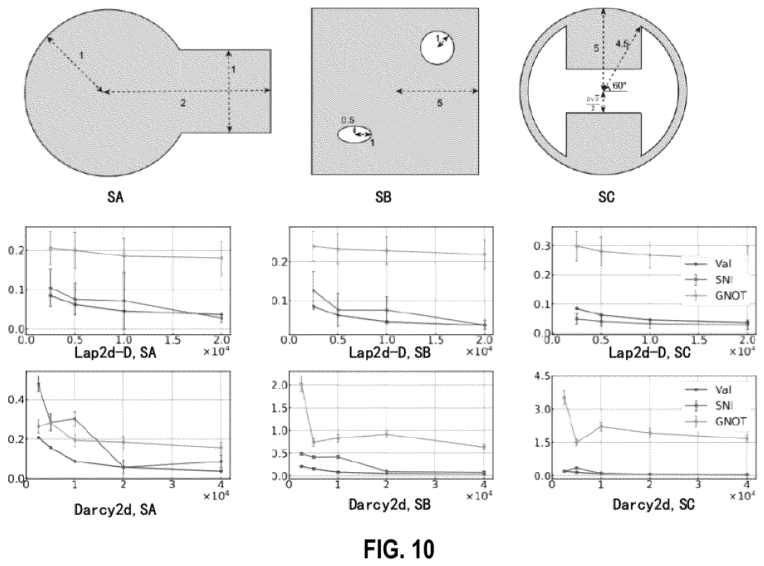

FIG. 10 shows a schematic diagram of shapes and the data efficiency of applying SNI to each shape according to examples of the present disclosure. In the first row of FIG. 10, shape SA, shape SB, and shape SC are shown from left to right, respectively.

In the second and third rows of the graph in FIG. 10, the horizontal axis represents the size of the training data set and the vertical axis represents the I₂ relative error. In the second row of FIG. 10, a comparison of the I₂ relative error between the results of direct inference using GNOT (orange), SNI-based inference (blue), and validation (red) is shown from left to right, respectively, where the Laplace2d-Dirichlet type PDE described herein for Equation (2) is respectively associated with shapes SA, SB, and SC. In the third row of FIG. 10, a comparison of the I₂ relative error between the results of direct inference using GNOT (orange), SNI-based inferences (blue), and validation (red) is shown, where the Darcy2d type PDE described herein for Equation (3) is respectively associated with shapes SA, SB, and SC. Of which, the results of the SNI-based inference and direct inference using GNOT are presented based on reasoning with 100 different boundary conditions. The best validation error during training is also provided as a reference.

Based on the results of SNI data efficiency as shown in FIG. 10, it can be seen that: (1) the relative error of I₂ in SNI is significantly lower than the relative error of GNOT direct inference under circumstances with abundant data; and (2) the error of SNI is equal to or even lower than the validation error with large amounts of data. (3) SNI requires smaller data sets to achieve results that are similar to GNOT direct inference. Taken together, these results suggest that SNI has a substantial advantage in terms of data efficiency. The framework proposed by the examples of the present disclosure has a significant ability to extract more information from limited data and can be extended more efficiently as the amount of data increases.

The method proposed in the examples of the present disclosure perform better on all static problems compared to the baseline that utilizes an NN model such as GNOT to train and reason about the entire shape of an object. The predicted error was reduced by 34.8%-96.8% across all shapes. The excellent performance demonstrates the effectiveness of the method proposed in the examples of the present disclosure in processing arbitrary shapes that are not included in the training data. In particular, since the simple polygons used in the training data may not be sufficiently similar to the complex test shapes, the method proposed in the examples of the present disclosure typically leads by a larger margin on more complex shapes. In addition, during the inference process, the performance of the method of the examples of the present disclosure is consistent when the shapes are different. Among all types of PDEs in the test data set, the difference in predicted error for various shapes was within 3.25%, demonstrating the ability to solve PDEs of various shapes with consistent accuracy using a single trained NN model.

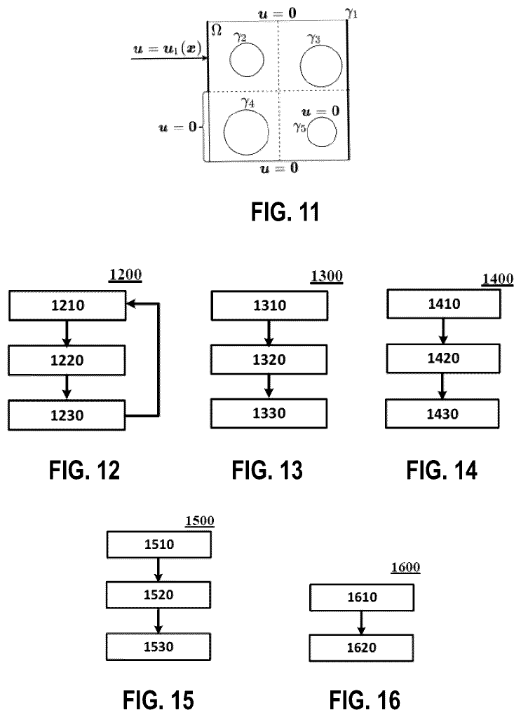

FIG. 11 shows a schematic diagram of an object having a shape according to one example. The physical system shown in FIG. 11 corresponds to a guide plate, where the PDE of the physical system associated with the guide plate may be:

$$Δ u ( x ) + {k}^{2} u ( x ) = f , x ∈ Q \qquad ( 8 a )$$

$$u ( x ) = u ( x ) , x ∈ {γ}_{1 left , up} \qquad ( 8 b )$$

$$u ( x ) = 0 , x ∈ {γ}_{wall} \qquad ( 8 c )$$

boundary γ₂ to γ₅ in the corresponding grid is the guide plate. Used for description according to physical law where x=(x₁, x₂) represents the spatial coordinates, u=(u₁, u₂) represents the velocity, k is a given constant, and f=f(x) is a given source term, γ_{1, left} represents the left half of γ₁, γ_{1, left, up} represents the upper half of γ_{1, left}, γ_{1, left, down} represents the lower half of γ_{1, left}, γ_{wall}=γ_{1, up}∪γ_{1, down}∪γ₂∪γ₃∪γ₄∪γ₅∪γ_{1, left, down}, and

$${u}_{1} ( x ) = {[ \frac{( 4 - {x}_{2} ) ( 8 - {x}_{2} )}{16} , 0 ]}^{⊤} .$$

In an example, the shape or domain of the object may be represented by geometric parameters that may include a center point and radius of a circle with a boundary. In one example, the shape or domain of an object can be represented by a set of discrete points, where each subset of the set of discrete points includes a discrete point on a corresponding boundary, and the discrete point can be represented by a coordinate. In one example, the shape or domain of an object may be represented by both the aforementioned set parameters and a set of discrete points.

For the exemplary guide plate shown in FIG. 11 and the physical system described by the PDE shown in Equations 8(a) to 8(c), training data may be generated by the method described in combination with FIG. 1 in the examples of the present disclosure, and an NN model for solving the PDE shown in Equations 8(a) to 8(c) for a basic shape to obtain a property state u can be trained. This NN model can be referred to as a local neural operator and can be used in the local solution module 620 shown in FIG. 6A to predict the solution u of the PDE for a sub-shape or sub-domain. Further, for the exemplary guide plate shown in FIG. 8 and the physical system described by the PDE shown in Equations 8(a) to 8(c), the physical state u of the guide plate may be determined by the process described in conjunction with FIG. 6A in examples of the present disclosure.

FIG. 12 shows a flow chart of a method for performing structural optimization on an object, such as a guide plate, according to one example. As shown in FIG. 11, the boundaries γ₂ to γ₅ in the grid are the guide plates to be structurally optimized. The goal of the structural optimization is to optimize the shape and position of the guide plates γ₂ to γ₅ to obtain a uniform distribution of fluid flow at the outlet γ_{1,right} on the right so that the energy dissipated by the fluid is very small.

The objective function of structural optimization may be formulated based on fluid mechanics as shown in Equation (15) below:

$$J ( W ) = \frac{1}{2} {\int }_{{γ}_{1 , right}} {\vert {u}_{1} - \overline{{u}_{1}} \vert}^{2} ds + β [ \frac{k}{2} {\int }_{Ω} {‖ ∇ {u}^{⊤} + ∇ u ‖}_{F}^{2} dx ] \qquad ( 9 )$$

Where β represents the equilibrium coefficient, for example, β=0.01, u=(u₁, u₂) represents the velocity, k represents the liquid viscosity, and the goal of structural optimization is to minimize J(W).

At Step 1210, a structural parameter quantity is determined, where the structural parameter quantity is used to describe the boundary of the object. For the guide plate shown in FIG. 11 as an object, the structural parameters can include the center and radius of the circular boundaries γ₂ to γ₅. For example, the structural feature W=(x₀, r₀, . . . , x₃, r₃).

At Step 1220, the physical state of the guide plate, i.e., velocity u=(u₁, u₂), is predicted using the SNI method according to one example of the present disclosure (e.g., in conjunction with the process shown in FIG. 6A).

At Step 1130, based on the predicted physical state u=(u₁, u₂) and Equation (15), J(W) is obtained, and based on J(W), the loss l(W) is obtained. For example, J(W) can be used as the loss l(W).

The method 1200 then returns to Step 1210, where the structural feature W=(x₀, r₀, . . . , x₃, r₃) is updated based on the loss l(W). The next round of iteration from Step 1120 to 1130 to 1110 is then performed based on the updated structural features.

It can be understood that any suitable method may be used to determine loss l(W) in Step 1130 and that the structural features in Step 1110 may be updated using any suitable method.

In the examples of FIGS. 11 and 12, the guide plate is taken as an example to describe the generation process of training data, the training process of local neural operators, the SNI reasoning process, and the structural optimization process of the object according to the examples of the present disclosure. It can be understood that the various processes described above of the examples of the present disclosure can be applied to various types of objects and various types of PDEs. For example, the object may be a fuel cell bipolar plate, a part of a car, a part of an airplane, a part of a building, a pipe of a reactor, a guide plate, etc., and the physical states associated with the object may include velocity, pressure, temperature, electric field, magnetic field, etc. By employing the methods of the examples of the present disclosure, it is possible to generate sufficient training data for the NN model so that the NN model provides ideal performance, and the physical state of objects of any shape can be determined based on this trained NN model, thereby improving the training and use efficiency of the NN model. It can be understood that when an object has a complex shape, the method according to the examples of the present disclosure has more obvious advantages than the traditional method of training the NN model for solving the entire shape. For example, it is easier to obtain training data for basic shapes, allowing the trained local neural operator to have better generalization ability, effectively process objects with complex shapes, and effectively process objects with large shape changes.

FIG. 13 shows a flow chart of a computer-implemented method 1300 for generating training data according to one example.

At Step 1310, a basic shape is generated.

At Step 1320, the boundary conditions associated with the first partial differential equation (PDE) are configured for the boundary of the basic shape.

At Step 1330, a solution of the first PDE for the basic shape is determined based on the basic shape and boundary conditions, where the solution represents the physical state of the object having the basic shape.

According to one example, training data is obtained based on the basic shape, boundary conditions, and solution.

According to one example, the basic shape is limited to a predetermined range. According to one example, the basic shape comprises a planar polygon with no self-intersections and no holes. According to one example, the planar polygon comprises n vertices and 3≤n≤12.

According to one example, the boundary conditions comprise a plurality of types of boundary conditions. According to one example, Step 1320 comprises: partitioning the boundary of the basic shape into a plurality of parts; and configuring one type of boundary condition from the plurality of types of boundary conditions for each of the plurality of parts. According to one example, the boundary conditions comprise a first type of boundary conditions and second type of boundary conditions of the second type, and Step 1320 comprises: partitioning the boundary of the basic shape into a first part and a second part; and configuring a first type of boundary condition for the first part and a second type condition for the second part. According to one example, the first type of boundary condition is a Dirichlet boundary condition and the second type of boundary condition is a Neumann boundary condition.

According to one example, the value of the boundary condition comprises a random value within a predetermined range.

According to one example, the method 1300 further comprises: configuring a PDE parameter function associated with the first PDE for the basic shape, the PDE parameter function comprising coefficients and/or source terms associated with the first PDE, wherein determining a solution of the first PDE for the basic shape comprises: determining a solution of the first PDE for the basic shape based on the basic shape, boundary conditions, and PDE parameter functions. According to one example, the value of the PDE parameter function comprises a random value within a predetermined range. According to one example, the method further comprises: based on at least one of the basic shape, the value of the boundary condition, the PDE parameter function, and the solution, performing data augmentation to obtain at least one of the data-augmented basic shape, the value of the data-augmented boundary condition, the data-augmented PDE parameter function, and the data-augmented solution; and wherein the training data is based on at least one of the data-augmented basic shape, the value of the data-augmented boundary condition, the data-augmented PDE parameter function and the data-augmented solution as well as the basic shape, the boundary condition, the PDE parameter function, and the solution. According to one example, performing data augmentation based on at least one of the basic shape, the values of the boundary conditions, the PDE parameter function, and the solution comprises performing at least one of: spatial translation, spatial scaling, and/or spatial rotation on the basic shape; and value offset and/or value scaling on at least one of the value of the boundary condition, the PDE parameter function, and the solution.

According to one example, the solution represents the physical state of an object having a basic shape over time.

FIG. 14 shows a flow chart of a computer-implemented method 1400 for training an NN model for determining the physical state of an object having a shape according to one example.

At Step 1410, based on the training data generated according to the method described herein, a solution for the basic shape in the training data is predicted by the NN model, wherein the solution represents the physical state of the object having the basic shape.

At Step 1420, the loss is determined based on the solution predicted by the NN model and the solution in the training data.

At Step 1430, the learnable parameters of the NN model are updated based on the loss.

FIG. 15 shows a flow chart of a computer-implemented method 1500 for determining the physical state of an object having a shape according to one example.

At Step 1510, the shape of the object is partitioned into a plurality of sub-shapes, wherein the full set of the plurality of sub-regions corresponding to the plurality of sub-shapes covers the complete area of the shape.

At Step 1520, based on the global boundary conditions for the shape and the plurality of sub-shapes, a local solution for each of the plurality of sub-shapes is obtained through a neural network (NN) model, and the local solution for each sub-shape represents the local physical state of the object with the sub-shape.

At Step 1530, based on the local solution for each of the plurality of sub-shapes, a global solution for the shape is obtained, and the global solution for the shape represents the physical state of the object.

According to one example, Step 1510 comprises: partitioning the shape into a plurality of non-overlapping sub-shapes to form the plurality of non-overlapping sub-shapes; or partitioning the shape into a plurality of overlapping sub-shapes to form the plurality of overlapping sub-shapes. According to one example, forming the plurality of overlapping sub-shapes comprises: partitioning the shape into a plurality of non-overlapping sub-shapes to form the plurality of non-overlapping intermediate sub-shapes; extending some or all of the plurality of non-overlapping intermediate sub-shapes to form the plurality of overlapping sub-shapes.

According to one example, Step 1520 comprises: a local solution for each of the plurality of sub-shapes is also obtained by the NN model based on a PDE parameter function for a differential equation (PDE) corresponding to the NN model, wherein the PDE parameter function comprises coefficients and/or source terms.

According to one example, Step 1520 comprises: obtaining a sub-shape preprocessing model and a sub-shape post-processing model based on the sub-shape and applying the sub-shape preprocessing model to the sub-shape to obtain a preprocessed sub-shape, and/or obtaining a PDE parameter function preprocessing model and a PDE parameter function post-processing model based on the PDE parameter function and applying the PDE parameter function preprocessing model to the PDE parameter function to obtain a preprocessed PDE parameter function; and obtaining a local solution for each of the plurality of sub-shapes based on the preprocessed sub-shape and/or the preprocessed PDE parameter function and based on the sub-shape post-processing model and/or the PDE parameter function post-processing model through the NN model.

According to one example, the local solution for each sub-shape and the global solution for the shape are obtained through a plurality of rounds of iteration, and Step 1520 comprises: setting local boundary conditions for the sub-shape based on the global boundary conditions and at least one of the global solutions for the previous round of the shape; and determining the local solution for the sub-shape through the NN model based on the sub-shape and the local boundary conditions for the sub-shape. According to one example, Step 1530 comprises: obtaining a value preprocessing model and a value post-processing model for the sub-shape based on the local boundary conditions for the sub-shape; applying the value preprocessing model to the local boundary conditions to obtain preprocessed local boundary conditions; determining an intermediate value of a local solution for the sub-shape through the NN model based on the sub-shape and the preprocessed local boundary conditions; and applying a value post-processing operator to the intermediate value of the local solution to obtain a local solution for the sub-shape.

According to one example, the local solution for each sub-shape and the global solution for the shape are obtained through a plurality of rounds of iteration, and Step 1530 comprises: obtaining a restriction model and an extension model for each sub-shape based on each sub-shape in a plurality of sub-shapes; obtaining an intermediate value of a global solution for the shape based on a local solution for each sub-shape and an extension model for each sub-shape, or obtaining an intermediate value of a global solution for the shape based on a local solution for each sub-shape, an extension model and a restriction model for each sub-shape, and a global solution for the previous round of the shape; and obtaining a global solution for the shape based on the intermediate value of the global solution for the shape and the global solution for the previous round of the shape.

According to one example, the solution for the shape represents the physical state of the object having that shape over time.

According to one example, the object is at least one of a fuel cell bipolar plate, a part of a car, a part of an airplane, a part of a building, a pipe of a reactor, and a guide plate, and wherein the physical state comprises at least one of velocity, pressure, temperature, electric field, and magnetic field.

According to one example, the shape of the object in the structural data is represented by at least one of the following: center of circle, radius, width, height, length, grid, or geometric shapes.

According to one example, the NN model is trained by a computer-implemented method described in the present text.

FIG. 16 shows a flow chart of a computer-implemented method 1600 for performing structural optimization of an object according to one example.

At Step 1610, the physical state of the object is predicted using the method described according to examples of the present disclosure.

At Step 1620, the structural features of the object are updated based on the predicted physical state of the object.

According to one example, Step 1620 comprises: updating the shape and/or material of the object based on the predicted physical state of the object.

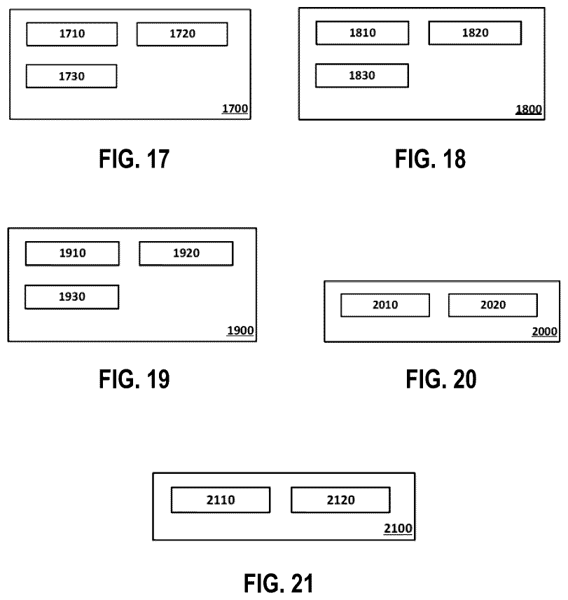

FIG. 17 shows a block diagram of an apparatus 1700 for generating training data according to one example.

The apparatus 1700 comprises a shape generation module 1710, a boundary condition module 1720, and a solution module 1730. The shape generation module 110 generates a basic shape S 115. The boundary condition module 1720 configures a boundary condition B 125 associated with the first partial differential equation (PDE) for the boundary of the basic shape. The solution module 1730 determines a solution u 135 of the first PDE for the basic shape based on the basic shape S 115 and the boundary condition B 125, wherein the solution represents the physical state of the object having the basic shape. According to one example, the training data is obtained based on the basic shape, boundary conditions, and reconciliation.

According to one example, the basic shape is limited to a predetermined range. According to one example, the basic shape comprises a planar polygon with no self-intersections and no holes. According to one example, the planar polygon comprises n vertices and 3≤n≤12.

According to one example, the boundary conditions comprise a plurality of types of boundary conditions. According to one example, the boundary condition module 1720 configures a boundary condition associated with the first PDE for the boundary of the basic shape by the following modules: a partitioning module for partitioning the boundary of the basic shape into a plurality of parts; and a boundary condition type configuration module for configuring one type of boundary condition from a plurality of types of boundary conditions for each of the plurality of parts. According to one example, the boundary conditions comprise a first type of boundary conditions and a second type of boundary conditions, and the partitioning module partitions the boundary of the basic shape into a first part and a second part; the boundary condition type configuration module configures the first type of boundary conditions for the first part and configures the second type of conditions for the second part. According to one example, the first type of boundary condition is a Dirichlet boundary condition and the second type of boundary condition is a Neumann boundary condition.

According to one example, the value of the boundary condition comprises a random value within a predetermined range.

According to one example, the apparatus 1700 further comprises a PDE parameter function module configured to configure a PDE parameter function associated with the first PDE for a basic shape, wherein the PDE parameter function comprises coefficients and/or source terms associated with the first PDE, and wherein the solution module determines a solution of the first PDE for the basic shape by: determining a solution of the first PDE for the basic shape based on the basic shape, boundary conditions, and PDE parameter functions. According to one example, the value of the PDE parameter function comprises a random value within a predetermined range. According to one example, the apparatus 1700 further comprises a data augmentation module, which, based on at least one of the basic shape, the value of the boundary condition, the PDE parameter function, and the solution, performs data augmentation to obtain at least one of the data-augmented basic shape, the value of the data-augmented boundary condition, the data-augmented PDE parameter function, and the data-augmented solution; and wherein the training data is based on at least one of the data-augmented basic shape, the value of the data-augmented boundary condition, the data-augmented PDE parameter function and the data-augmented solution as well as the basic shape, the boundary condition, the PDE parameter function, and the solution. According to one example, the data augmentation module performs at least one of the following to perform data augmentation based on at least one of the basic shape, the values of the boundary conditions, the PDE parameter function, and the solution: spatial translation, spatial scaling, and/or spatial rotation on the basic shape; and value offset and/or value scaling on at least one of the value of the boundary condition, the PDE parameter function, and the solution.

According to one example, the solution represents the physical state of an object having a basic shape over time.

FIG. 18 shows a block diagram of an apparatus 1800 for training an NN model for determining the physical state of an object having a shape according to one example.

The apparatus 1800 comprises an NN model 1810, a loss module 1820, and an update module 1830. The NN model 1810, based on the training data generated according to the method described herein, predicts a solution for the basic shape in the training data, wherein the solution represents the physical state of the object having the basic shape. The loss module 1820 determines the loss based on the solution predicted by the NN model and the solution in the training data. The update module 1830 updates the learnable parameters of the NN model based on the loss.

FIG. 19 shows a block diagram of an apparatus 1900 for determining the physical state of an object having a shape according to one example.

The apparatus 1900 comprises a partitioning module 1910, a local solution module 1920, and a global solution module 1930. The partitioning module 1910 partitions the shape of the object into a plurality of sub-shapes, wherein a full set of a plurality of sub-regions corresponding to the plurality of sub-shapes covers the complete area of the shape. The local solution module 1920, based on the global boundary conditions for the shape and the plurality of sub-shapes, obtains a local solution for each of the plurality of sub-shapes through a neural network (NN) model, and the local solution for each sub-shape represents the local physical state of the object with the sub-shape. The global solution module 1930, based on the local solution for each of the plurality of sub-shapes, obtains a global solution for the shape, and the global solution for the shape represents the physical state of the object.

According to one example, the partitioning module 1910 partitions the shape into the plurality of sub-shapes by comprising the following modules: a non-overlapping partitioning module, which partitions the shape into a plurality of non-overlapping sub-shapes to form the plurality of non-overlapping sub-shapes; or an overlapping partitioning module, which partitions the shape into a plurality of overlapping sub-shapes to form the plurality of overlapping sub-shapes. According to one example, the overlapping partitioning module forms the plurality of overlapping sub-shapes by comprising the following modules: an intermediate partitioning module, which partitions the shape into a plurality of non-overlapping sub-shapes to form the plurality of non-overlapping intermediate sub-shapes; and a shape extension module, which extends some or all of the plurality of non-overlapping intermediate sub-shapes to form the plurality of overlapping sub-shapes.

According to one example, the local solution module 1920 also obtains a local solution for each of the plurality of sub-shapes by performing the following operation: further obtaining a local solution for each of the plurality of sub-shapes by the NN model based on a PDE parameter function for a differential equation (PDE) corresponding to the NN model, wherein the PDE parameter function comprises coefficients and/or source terms.

According to one example, the local solution module 1920 obtains a local solution for each of the plurality of sub-shapes through the NN model by the following modules: a sub-shape model generation module, which obtains a sub-shape preprocessing model and a sub-shape post-processing model based on the sub-shape, and a sub-shape preprocessing module, which applies the sub-shape preprocessing model to the sub-shape to obtain a preprocessed sub-shape, and/or a PDE parameter function model generation module, which obtains a PDE parameter function preprocessing model and a PDE parameter function post-processing model based on the PDE parameter function, and a PDE parameter function preprocessing module, which applies the PDE parameter function preprocessing model to the PDE parameter function to obtain a preprocessed PDE parameter function; and the NN model obtains a local solution for each of a plurality of sub-shapes based on the preprocessed sub-shape and/or the preprocessed PDE parameter function and based on the sub-shape post-processing model and/or the PDE parameter function post-processing model.

According to one example, a local solution for each sub-shape and the global solution for the shape are obtained through a plurality of rounds of iteration, and the local solution module 1920 obtains, by the NN model, a local solution for each of the plurality of sub-shapes by comprising the following modules: a local boundary condition module, which sets local boundary conditions for the sub-shape based on the global boundary conditions and at least one of the global solutions for the previous round of the shape; and a local solution determination module, which determines the local solution for the sub-shape through the NN model based on the sub-shape and the local boundary conditions for the sub-shape. According to one example, the local solution module 1920 determines, by the NN model, a local solution for the sub-shape based on the sub-shape and local boundary conditions for the sub-shape by comprising the following modules: a value model generation module, which obtains a value preprocessing model and a value post-processing model for the sub-shape based on the local boundary conditions for the sub-shape; a value preprocessing module, which applies the value preprocessing model to the local boundary conditions to obtain preprocessed local boundary conditions; the NN model determines an intermediate value of a local solution for the sub-shape based on the sub-shape and the preprocessed local boundary conditions; and a post-processing module, which applies a value post-processing model to the intermediate value of the local solution to obtain a local solution for the sub-shape.

According to one example, the local solution for each sub-shape and the global solution for the shape are obtained through a plurality of rounds of iteration, and the global solution module 1930 obtains the global solution for the shape based on the local solution for each sub-shape in the plurality of sub-shapes by comprising the following modules: a restriction and extension model generation module, which obtains a restriction model and an extension model for each sub-shape based on each sub-shape in a plurality of sub-shapes; and a concatenation module, which obtains an intermediate value of a global solution for the shape based on a local solution for each sub-shape and an extension model for each sub-shape, or obtains an intermediate value of a global solution for the shape based on a local solution for each sub-shape, an extension model and a restriction model for each sub-shape, and a global solution for the previous round of the shape; and an update module, which obtains a global solution for the shape based on the intermediate value of the global solution for the shape and the global solution for the previous round of the shape.

According to one example, the solution for the shape represents the physical state of the object having the shape over time.

According to one example, the object is at least one of a fuel cell bipolar plate, a part of a car, a part of an airplane, a part of a building, a pipe of a reactor, and a guide plate, and wherein the physical state comprises at least one of velocity, pressure, temperature, electric field, and magnetic field.

According to one example, the shape of the object in the structural data is represented by at least one of the following: Center of circle, radius, width, height, length, grid, or geometric pattern.

According to one example, the NN model is trained according to the computer-implemented method described herein.

FIG. 20 shows a flow chart of a computer-implemented method 2000 for performing structural optimization on an object according to one example.

The apparatus 2000 comprises a prediction module 2010 and an update module 2020. The prediction module 2010 uses the method described according to the examples of the present disclosure to predict the physical state of the object. The update module 2020 updates the structural features of the object based on the predicted physical state of the object.

According to one example, the update module 2020 updates the shape and/or material of the object based on the predicted physical state of the object.

FIG. 21 shows a block diagram of a processing apparatus 2100 according to one example.

The processing apparatus or processing system 2100 comprises one or more control units or processing units 2110 that execute one or more machine-readable instructions stored or encoded in a machine-readable storage medium (i.e., memory 2120). In one example, the processing unit 2110, when executing the program instructions, is configured to perform various operations and functions described above in connection with FIGS. 1-9.

Although not shown in FIG. 1, FIG. 2C, FIG. 3C, FIG. 5, FIG. 6A, FIGS. 7C-9, and FIGS. 17-21, it will be understood by those skilled in the art that the apparatus described in the examples of the present disclosure may also comprise various other components, such as various communication modules, bus modules, possible user interface modules, etc.

According to one example, a program product, such as a non-transitory machine-readable medium, is provided. The non-transitory machine-readable medium may have instructions that, when executed by the processing unit 2110, are capable of performing various operations and functions described above in connection with FIGS. 1 to 20 in various examples of the examples of the present disclosure.

According to one example, a computer program product is provided. The computer program product comprises computer-executable instructions that, when executed by the processing unit 2110, are capable of performing various operations and functions described above in connection with FIGS. 1 to 20 in various examples of the present disclosure.

Exemplary examples are described above with reference to the specific embodiments described in the accompanying drawings, but do not represent all examples that may be implemented or fall within the scope of protection of the patent claims. Throughout the present specification, the term “exemplary” means “serving as an example, instance, or illustration” and does not imply “preferred” or “advantageous” over other examples. Specific examples comprise specific details to facilitate understanding of the described technology. However, these technologies may be implemented without these specific details. In some instances, to avoid causing difficulties in understanding the concepts of the described examples, known structures and apparatuses are shown in block diagram form.

The aforementioned description of the present application is provided to allow any person of ordinary skill in the art to implement or use the present application. Various modifications to the present application will be apparent to those of ordinary skill in the art, and the general principles defined herein may be applied to other variations without departing from the scope of protection of the present application. Therefore, the present application is not limited to the exemplary examples and designs described herein but is consistent with the broadest scope defined by the principles and novel features disclosed herein.

1. A computer-implemented method for generating training data, comprising:
generating a basic shape;
configuring the boundary conditions associated with a first partial differential equation (PDE) for the boundary of the basic shape; and
determining a solution of the first PDE for the basic shape based on the basic shape and the boundary conditions, wherein the solution represents the physical state of an object having the basic shape,
wherein the training data is obtained based on the basic shape, the boundary conditions, and the solution.

2. The computer-implemented method according to claim 1, wherein the basic shape is constrained to be within a predetermined range.

3. The computer-implemented method according to claim 1, wherein the basic shape comprises a planar polygon with no self-intersections and no holes.

4. The computer-implemented method according to claim 3, wherein the planar polygon comprises n vertices and 3≤n≤12.

5. The computer-implemented method according to claim 1, wherein the boundary conditions comprise a plurality of types of boundary conditions, and wherein configuring the boundary conditions associated with the first PDE for the boundary of the basic shape comprises:
partitioning the boundary of the basic shape into a plurality of parts; and
configuring one type of boundary condition from among the plurality of types of boundary conditions for each of the plurality of parts.

6. The computer-implemented method according to claim 5, wherein the boundary conditions comprise a first type and a second type of boundary conditions, and wherein configuring the boundary conditions associated with the first PDE for the boundary of the basic shape comprises:
partitioning the boundary of the basic shape into a first part and a second part; and
configuring the first type of boundary condition for the first part and the second type of condition for the second part, wherein the first type of boundary condition is the Dirichlet boundary condition and the second type of boundary condition is the Neumann boundary condition.

7. The computer-implemented method according to claim 1, wherein the value of the boundary condition comprises a random value within a predetermined range.

8. The computer-implemented method according to claim 1, further comprising: configuring, for the basic shape, a PDE parameter function associated with the first PDE, the PDE parameter function comprising coefficients, and/or source terms associated with the first PDE, wherein determining a solution of the first PDE for the basic shape comprises: determining a solution of the first PDE for the basic shape based on the basic shape, the boundary conditions, and the PDE parameter function.

9. The computer-implemented method according to claim 8, wherein the value of the PDE parameter function comprises a random value within a predetermined range.

10. The computer-implemented method according to claim 8, further comprising:
performing data augmentation based on at least one of the basic shape, the value of the boundary condition, the PDE parameter function, and the solution to correspondingly obtain at least one of a data-augmented basic shape, a data-augmented value of the boundary condition, a data-augmented PDE parameter function, and a data-augmented solution; and
the training data is based on at least one of a data-augmented basic shape, a value of a data-augmented boundary condition, a data-augmented PDE parameter function, and a data-augmented solution and is obtained based on the basic shape, the boundary conditions, the PDE parameter function, and the solution.

11. The computer-implemented method according to claim 10, wherein performing data augmentation based on at least one of the basic shape, the value of the boundary condition, the PDE parameter function, and the solution comprises performing at least one of:
performing spatial translation, spatial scaling, and/or spatial rotation on the basic shape; and
performing value shifting and/or value scaling on at least one of the value of the boundary condition, the PDE parameter function, and the solution.

12. The computer-implemented method according to claim 1, wherein the solution represents the physical state of an object having the basic shape over time.

13. A computer-implemented method for training a neural network (NN) model for determining the physical state of an object having a shape, comprising:
predicting, by the NN model, a solution for a basic shape in the training data based on the training data generated by the method according to claim 1, wherein the solution represents the physical state of an object having the basic shape;
determining a loss based on a solution predicted by the NN model and a solution in the training data; and
updating a learnable parameter of the NN model based on the loss.

14. A computer-implemented method for determining the physical state of an object having a shape, comprising:
partitioning the shape of the object into a plurality of sub-shapes, wherein a full set of a plurality of sub-regions corresponding to the plurality of sub-shapes covers the complete area of the shape;
obtaining, based on the global boundary conditions for the shape and the plurality of sub-shapes, a local solution for each of the plurality of sub-shapes using a neural network (NN) model trained by the computer-implemented method according to claim 13, the local solution for each sub-shape representing a local physical state of the object having the sub-shape; and
obtaining a global solution for the shape based on the local solution for each of the plurality of sub-shapes, the global solution for the shape representing the physical state of the object.

15. An apparatus for generating training data, comprising:
a shape generation module that generates a basic shape;
a boundary condition module that configures the boundary conditions associated with a first partial differential equation (PDE) for the boundary of the basic shape;
a solution module that determines a solution of the first PDE for the basic shape based on the basic shape and the boundary conditions, wherein the solution represents the physical state of an object having the basic shape; and
training data obtained based on the basic shape, the boundary conditions, and the solution.

16. An apparatus for training a neural network (NN) model for determining the physical state of an object having a shape, comprising:
a neutral network (NN) model that predicts a solution for a basic shape based on the basic shape and boundary conditions in the training data generated by the method according to claim 1, wherein the solution represents the physical state of an object having the basic shape;
a loss module that determines a loss based on a solution predicted by the NN model and a solution in the training data; and
an update module that updates a learnable parameter of the NN model based on the loss.

17. An apparatus for determining the physical state of an object having a shape, comprising:
a partitioning module that partitions the shape of the object into a plurality of sub-shapes, wherein a full set of a plurality of sub-regions corresponding to the plurality of sub-shapes covers the complete area of the shape;
a local solution model that obtains, based on the global boundary conditions for the shape and the plurality of sub-shapes, a local solution for each of the plurality of sub-shapes using a neural network (NN) model trained by the computer-implemented method according to claim 13, the local solution for each sub-shape representing a local physical state of the object having the sub-shape; and
a global solution model that obtains a global solution for the shape based on the local solution for each of the plurality of sub-shapes, the global solution for the shape representing the physical state of the object.

18. A processing apparatus, comprising:
one or more processors; and
one or more memories, the memories having computer-executable instructions stored thereon, and the instructions, when run by the one or more processors, perform the operations of claim 1.

19. A machine-readable storage medium having executable instructions stored thereon, the instructions, when executed, causing one or more processors to perform the method according to claim 1.

20. A computer program product comprising executable instructions that, when executed, cause one or more processors to perform the method according to claim 1.
